(19) United States
(12) Patent Application Publication
(10) Pub. No.: US 2012/0015090 A1
(43) Pub. Date: Jan. 19, 2012

(54) READILY WATER-SOLUBLE MYRICITRIN COMPOSITION

(75) Inventors: Kazuhiro Emura, Osaka (JP); Hiroshi Oka, Osaka (JP); Hisashi Tanaka, Osaka (JP)

(73) Assignee: SAN-EI GEN F.F.I., INC., Toyonaka-shi (JP)

(21) Appl. No.: 13/258,531

(22) PCT Filed: Mar. 24, 2010
(86) PCT No.: PCT/JP2010/055113

§ 371 Date: Sep. 22, 2011

(30) Foreign Application Priority Data
Mar. 25, 2009 (JP) 2009-074936

(51) Int. Cl. C11B 5/00

(52) U.S. Cl. 426/545

(57) ABSTRACT

Disclosed is a method for improving the solubility of myricitrin in water. Also disclosed is a readily water-soluble myricitrin composition which has improved solubility in water due to the method. Specifically disclosed is a method for preparing a myricitrin inclusion product, which comprises including myricitrin in γ-cyclodextrin in the proportion of 1 to 7 mol of γ-cyclodextrin to 1 mol of myricitrin.

### 1. TECHNICAL FIELD

The present invention relates to a readily water-soluble myricitrin composition that has improved solubility in water compared to the myricitrin itself. The present invention also relates to a method for producing the readily water-soluble myricitrin composition. Further, the present invention relates to a method for improving the solubility of myricitrin in water.

The present invention also relates to uses of the readily water-soluble myricitrin composition, specifically uses as a color deterioration suppressing agent and a flavor deterioration suppressing agent.

### 2. BACKGROUND ART

Flavonol derivatives such as rutin and myricitrin generally have an antioxidative effect and radical scavenging effect. Flavonol derivatives are thus used as food additives such as antioxidants, fading preventing agents, and flavor deterioration preventing agents. There are also reports that flavonol derivatives are effective for the prevention of diseases that involve factors such as free radicals and active oxygen.

A problem of rutin and other flavonol derivatives, however, is that these compounds generally have poor solubility in water, and are unstable in aqueous solutions. At high concentration, flavonol derivatives may form precipitates by forming insoluble matter over time in an acidic aqueous solution, or in an alkaline aqueous solution, in which the flavonol derivatives have high solubility. The poor dissolution stability of flavonol derivatives is detrimental to the appearance of food, and makes the food difficult to ingest.

Accordingly, methods that stably mix poorly water-soluble flavonol derivatives in an aqueous solution at high concentrations have been studied. For example, Patent Literature 1 describes including rutin in β- or γ-cyclodextrin, and thereby improving the solubility of rutin in water. Patent Literature 2 describes including rutin in cyclodextrin under alkaline conditions to improve the rutin solubility in a low temperature range. Patent Literature 3 describes performing an alkali treatment for an isoflavone derivative included in β- or γ-cyclodextrin to further improve solubility in water. Patent Literature 4 describes including a poorly water-soluble flavonoid in β-cyclodextrin in an alkaline aqueous solution or in a mixture of water and organic solvent, or in the presence of a supercritical to subcritical aqueous solvent, and mixing enzyme-treated hesperidin therewith to prepare a water-soluble flavonoid composition that has improved solubility in water.

### CITATION LIST

### Patent Literature

PTL 1: JP-A-59-137499
PTL 2: JP-A-06-054664
PTL 3: JP-A-2004-238336
PTL 4: JP-A-2008-271839

### SUMMARY OF INVENTION

### Technical Problem

As described above, it is known that including poorly water-soluble flavonol derivatives such as rutin in cyclodextrin has certain effects in improving water solubility. However, it is thought that this inclusion method can increase water solubility only by a factor of, at most, about 10 to 15 in the case of rutin; and there is a need for ingenuity to further improve water solubility.

It is an object of the present invention to provide a method for greatly improving the solubility of poorly water-soluble myricitrin, which is a myricetin glycoside, in water, and a readily water-soluble myricitrin composition that has greatly improved water solubility. Another object is to provide various uses of the readily water-soluble myricitrin composition.

### Solution to Problem

The present inventors conducted intensive studies to solve the foregoing problems, and found that a myricitrin composition obtained by including γ-cyclodextrin in a proportion of 1 to 7 moles per mole of myricitrin can have improved water solubility over the non-included myricitrin by a factor of 90 or more in terms of myricitrin. Further, it was confirmed that the readily water-soluble myricitrin composition has better lightfastness (degradation resistance) in acidic drinks than that of the myricitrin, and that a drink mixed with the composition does not undergo undesirable changes such as formation of precipitations and turbidity even when preserved under low temperature to 60° C. conditions, regardless of whether the drink is acidic or alkaline. Specifically, it was confirmed that the readily water-soluble myricitrin composition can be used to prepare an aqueous food that excels in myricitrin preservation stability. The present inventors also confirmed that the readily water-soluble myricitrin composition has better fading suppressing effect and flavor deterioration suppressing effect than that of the myricitrin itself.

The present invention has been completed based on these findings, and has the following aspects.

### (I) Readily Water-Soluble Myricitrin Composition

(I-1) A readily water-soluble myricitrin composition that includes γ-cyclodextrin in a proportion of 1 to 7 moles per mole of myricitrin.
(I-2) A readily water-soluble myricitrin composition that includes γ-cyclodextrin in a proportion of 2 to 4 moles per mole of myricitrin.
(I-3) The readily water-soluble myricitrin composition according to (I-1) or (I-2), wherein the myricitrin is an inclusion product of the γ-cyclodextrin.
(I-4) The readily water-soluble myricitrin composition according to (I-1) or (I-3), wherein the solubility of the readily water-soluble myricitrin composition in water in terms of myricitrin under the condition shaking for 40 hours at 25° C., is 90 times or higher, preferably 90 to 300 times higher than the solubility of the myricitrin alone.
(I-5) The readily water-soluble myricitrin composition according to (I-1) or (I-3), wherein the solubility of the readily water-soluble myricitrin composition in water in terms of myricitrin under the condition shaking for 40 hours at 25° C., is 10 mg/ml or more, preferably 10 to 30 mg/ml.
(I-6) The readily water-soluble myricitrin composition according to (I-2) or (I-3), wherein the solubility of the readily water-soluble myricitrin composition in water in terms of myricitrin under the condition shaking for 40 hours at 25° C., is 200 times or higher, preferably 200 to 300 times higher than the solubility of the myricitrin alone.
(I-7) The readily water-soluble myricitrin composition according to (I-2) or (I-3), wherein the solubility of the readily water-soluble myricitrin composition in water in terms of myricitrin under the condition shaking for 40 hours at 25° C., is 23 mg/ml or more, preferably 23 to 30 mg/ml.
(I-8) The readily water-soluble myricitrin composition according to any one of (I-1) to (I-7), wherein the readily water-soluble myricitrin composition is a color deterioration suppressing agent.
(I-9) The readily water-soluble myricitrin composition according to any one of (I-1) to (I-7), wherein the readily water-soluble myricitrin composition is a flavor deterioration suppressing agent.

### (II) Readily Water-Soluble Myricitrin Composition Producing Method

(II-1) A method for producing the readily water-soluble myricitrin composition of (I-1), (I-3), (I-4) or (I-5), the method comprising including the myricitrin in the γ-cyclodextrin in a proportion of 1 to 7 moles of the γ-cyclodextrin per mole of the myricitrin.
(II-2) The method according to (II-1), comprising subjecting a mixture that contains 1 to 7 moles of γ-cyclodextrin per mole of myricitrin to the following steps:
(1) dissolving the mixture to a heated aqueous solution, and
(2) drying the aqueous solution.
   (II-3) The method according to (II-2), comprising the step of clarifying the aqueous solution between the steps (1) and (2).
   (II-4) A method for producing the readily water-soluble myricitrin composition of (I-2), (I-3), (I-6), or (I-7), the method comprising including the myricitrin in the γ-cyclodextrin in a proportion of 2 to 4 moles of the γ-cyclodextrin per mole of the myricitrin.
   (II-5) The method according to (II-4), comprising subjecting a mixture that contains 2 to 4 moles of γ-cyclodextrin per mole of myricitrin to the following steps:
(1) dissolving the mixture in a heated aqueous solution, and
(2) drying the aqueous solution.
   (II-6) The method according to (II-5), comprising the step of clarifying the aqueous solution between the steps (1) and (2).
   (II-7) The method according to (II-2) or (II-5), wherein the heated aqueous solution has a temperature of 50° C. or more.

### (III) Edible Composition Containing Readily Water-Soluble Myricitrin Composition

(III-1) An edible composition that includes the readily water-soluble myricitrin composition of any one of (I-1) to (I-7) in the state of being dissolved in water or in aqueous ethanol.
(III-2) An edible composition according to (III-1), wherein the edible composition is a drink.
(III-3) An edible composition according to (III-1) or (III-2), wherein the edible composition is an acidic drink.
(III-4) An edible composition obtained by solidifying the edible composition of (III-1).

### (IV) Myricitrin Water-Solubility Improving Method

(IV-1) A method for improving solubility of myricitrin in water, the method comprising including myricitrin in γ-cyclodextrin in a proportion of 1 to 7 moles of the γ-cyclodextrin per mole of the myricitrin, so as to produce a myricitrin inclusion product of γ-cyclodextrin.
(IV-2) The method according to (IV-1), comprising subjecting a mixture that contains 1 to 7 moles of γ-cyclodextrin per mole of myricitrin to the following steps:
(1) dissolving the mixture in a heated aqueous solution, and
(2) drying the aqueous solution.
   (IV-3) The method according to (IV-2), comprising the step of clarifying the aqueous solution between the steps (1) and (2).
   (IV-4) The method according to any one of (IV-1) to (IV-3), wherein the solubility in water at 25° C. in terms of myricitrin is improved 90 times or higher, preferably 90 to 300 times from the solubility of the myricitrin itself.
   (IV-5) A method for improving solubility of myricitrin in water, the method comprising including myricitrin in γ-cyclodextrin in a proportion of 2 to 4 moles of the γ-cyclodextrin per mole of the myricitrin, so as to produce a myricitrin inclusion product of γ-cyclodextrin.
   (IV-6) The method according to (IV-5), comprising subjecting a mixture that contains 2 to 4 moles of γ-cyclodextrin per mole of myricitrin to the following steps:
(1) dissolving the mixture in a heated aqueous solution, and
(2) drying the aqueous solution.
   (IV-7) The method according to (IV-6), comprising the step of clarifying the aqueous solution between the steps (1) and (2).
   (IV-8) The method according to any one of (IV-5) to (IV-7), wherein the solubility in water at 25° C. in terms of myricitrin is improved 200 times or higher, preferably 200 to 300 times from the solubility of the myricitrin itself.

### (V) Color Deterioration Suppressing Agent and Color Deterioration Suppressing Method

(V-1) A color deterioration suppressing agent for a colorant that contains the readily water-soluble myricitrin composition of any one of (I-1) to (I-7) as an active ingredient.
(V-2) A color deterioration suppressing agent according to (V-1), wherein the colorant suppressed from fading is a natural colorant.
(V-3) A color deterioration suppressing agent according to (V-1) or (V-2), wherein the colorant suppressed from fading is an anthocyanin-based colorant, a flavonoid-based colorant, a carotenoid-based colorant, a quinone-based colorant, an azaphilone-based colorant, or gardenia blue.
(V-4) A color deterioration suppressing agent according to any one of (V-1) to (V-3), wherein the color deterioration suppressing agent is against photoirradiation.
(V-5) A colorant preparation that comprises a colorant with a color deterioration suppressing agent of any one of (V-1) to (V-4).
(V-6) A colorant preparation according to (V-5), wherein the colorant is a natural colorant.
(V-7) A colorant preparation according to (V-6), wherein the colorant is an anthocyanin-based colorant, a flavonoid-based colorant, a carotenoid-based colorant, a quinone-based colorant, an azaphilone-based colorant, or gardenia blue colorant.
(V-8) A fading-suppressed colored food or drink that contains a color deterioration suppressing agent of any one of (V-1) to (V-4).
(V-9) A color deterioration suppressing method for a colorant or a colorant-containing composition, the method comprising having the colorant or the colorant-containing composition coexist with the readily water-soluble myricitrin composition of any one of (I-1) to (I-7).
(V-10) A color deterioration suppressing method according to (V-9), wherein the colorant is an anthocyanin-based colorant, a flavonoid-based colorant, a carotenoid-based colorant, a quinone-based colorant, an azaphilone-based colorant, or gardenia blue colorant.

### (VI) Flavor Deterioration Suppressing Agent and Flavor Deterioration Suppressing Method

(VI-1) A flavor deterioration suppressing agent that comprises the readily water-soluble myricitrin composition of any one of (I-1) to (I-7) as an active ingredient.
(VI-2) A flavor deterioration suppressing agent according to (VI-1), wherein the flavor is a citrus- or milk-based flavor.
(VI-3) A scented product that contains a flavor component with a flavor deterioration suppressing agent of (VI-1) or (VI-2).
(VI-4) A scented product according to (VI-3), wherein the flavor component has a citrus- or milk-based flavor.
(VI-5) A scented product according to (VI-3) or (VI-4), wherein the scented product is a food or a drink.
(VI-6) A flavor deterioration suppressing method for a flavor component-containing composition subject to flavor deterioration, the method comprising having the readily water-soluble myricitrin composition of any one of (I-1) to (I-7) is coexisted with said composition.
(VI-7) A flavor deterioration suppressing method according to (VI-6), wherein the flavor component has a citrus- or milk-based flavor.

### Advantageous Effects of Invention

The myricitrin composition of the present invention including γ-cyclodextrin in a proportion of 1 to 7 moles, preferably 2 to 4 moles per mole of myricitrin has improved solubility in water over the non-included myricitrin by a factor of 90 or more, preferably 200 or more. Further, the readily water-soluble myricitrin composition has better lightfastness (degradation resistance) in acidic drinks than that of the myricitrin. Further, a drink mixed with the composition does not undergo undesirable changes such as formation of precipitations and turbidity even when preserved under low temperature to 60° C. conditions, regardless of whether the drink is acidic or alkaline. It is therefore possible to prepare an aqueous food that excels in preservation stability. Furthermore, the readily water-soluble myricitrin composition is superior to the myricitrin itself with regard to fading suppressing effect and flavor deterioration suppressing effect.

### BRIEF DESCRIPTION OF DRAWINGS

FIG. 1 represents the results of Experiment Example 1 in which the solubility of myricitrin in water was examined using the myricitrin itself (non-included myricitrin), and various myricitrin compositions that contained varying amounts of γ-cyclodextrin with respect to myricitrin; the upper diagram represents the myricitrin solubility (mg/ml) obtained from using the myricitrin and myricitrin composition, the lower diagram represents the myricitrin solubility (mg/ml) of the myricitrin composition as the relative ratio (fold) with respect to the reference solubility (mg/ml) 1 of the myricitrin itself (myricitrin:γ-CD=1:0).

FIG. 2 represents the results of Experiment Example 2 which calculated the relative ratio (fold) of the water solubility of various flavonoid compositions prepared by varying the mixed amount of γ-cyclodextrin for various flavonoids (myricitrin, quercetin, myricetin, rutin, and naringin) with respect to the reference solubility (mg/ml) 1 of the flavonoid itself (flavonoid:γ-CD=1:0).

FIG. 3 represents the results of Experiment Example 4 which examined a myricetin residual rate of an acid drink (pH 3, 4, 5), which contains myricetin itself (-♦-, -▪-, -▴-) or a myricitrin inclusion product of γ-cyclodextrin (-⋄-, -□-, -Δ-) after the drink was irradiated with ultraviolet using a UV Fade Meter.

### DESCRIPTION OF EMBODIMENTS

### (1) Readily Water-Soluble Myricitrin Composition, and Method of Production Thereof

The myricitrin of the present invention is a flavonol glycoside that has a rhamnosyl attached to position 3 of myricetin, as represented by the formula below.

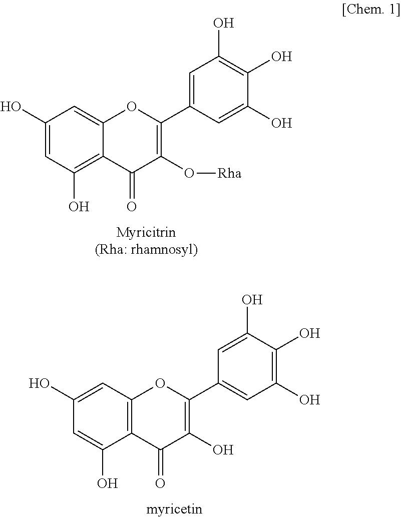

The myricitrin is commercially available from, for example, Funakoshi Corporation.

Cyclodextrins are crown-shaped nonreducing maltooligosaccharides with 6 to 12 glucose molecules linked together in a ring with α-1,4 glucoside bonds. Cyclodextrins are produced from starch acted upon by cyclodextrin-producing enzymes that originate in, for example, Bacillus macerans. Typical cyclodextrins include a-cyclodextrin with six glucose molecules, β-cyclodextrin with seven glucose molecules, and γ-cyclodextrin with eight glucose molecules. The cyclodextrin suited for the preparation of the myricitrin composition of the present invention is γ-cyclodextrin, which can be used to desirably obtain the effects of the present invention. Branched or methylated cyclodextrins with improved solubility, or mixtures of α-cyclodextrin, β-cyclodextrin, and γ-cyclodextrin can also be used.

The myricitrin composition of the present invention can easily be prepared by mixing myricitrin and γ-cyclodextrin. The mixing method may be, for example, a kneading method, a dissolving method, or a mixing and pulverizing method. The preferred method is a dissolving method.

### (a) Kneading Method

γ-Cyclodextrin is mixed with myricitrin in a proportion of 1 to 7 moles per mole of myricitrin. Then, water is added in 0.5 to 5 times the amount of the mixture. The product is then kneaded into a paste, and dried.

Kneading may be performed typically at 5 to 100° C.; however, a more efficient treatment is possible at 100 to 160° C. with the use of a pressurized vessel. Kneading time is not particularly limited, and may be about 30 minutes to 3 hours. Devices such as a mixing-grinding machine, a bowl mill, and an emulsification equipment may be used for kneading. The paste after the inclusion may be dried and formed into a powder, as required, using methods such as reduced-pressure drying, and drum drying.

### (b) Dissolving Method

γ-Cyclodextrin is mixed with myricitrin in a proportion of 1 to 7 moles per mole of myricitrin. The mixture is heat-dissolved in water in about 1 to 50 mass %, and the resulting aqueous solution is dried.

When used in transparent drinks such as soft drinks, it is preferable that the heat-dissolving of the myricitrin and γ-cyclodextrin in water be followed by a clarification treatment such as filtration, before drying the resulting aqueous solution.

The mixture may be dissolved in water typically at 50 to 100° C., preferably 70 to 100° C. Further, to help ease the process, the dissolving may be performed at 100° C. or higher, preferably 100 to 165° C., more preferably 110 to 140° C., by an indirect heat treatment using, for example, a plate heater, a pressurized heat treatment using, for example, retort sterilization, or a direct heat treatment using steam such as in steam injection, and steam infusion.

Further, an aqueous solution of lower alcohols such as methanol, ethanol, and isopropanol (25 mass % or less) may be used instead of water.

The method used to dry the aqueous solution is not particularly limited. The aqueous solution is typically dried using methods such as spray-drying, reduced-pressure drying, drum drying, and freeze-drying.

The myricitrin and γ-cyclodextrin may be mixed under alkaline conditions to adjust the amount of the myricitrin included. Typically, the mixture may be placed under alkaline conditions by using methods that use one or more alkalis used as food additives, such as sodium hydroxide, sodium carbonate, sodium bicarbonate, sodium acetate, sodium citrate, potassium hydroxide, potassium carbonate, potassium phosphate, calcium hydroxide, calcium carbonate, and kansui (brine). The preferred alkaline condition is pH 7 to 10, preferably pH 7 to 8.

Inclusion under alkaline conditions is not limited, and may be performed as follows. One to three parts by mass of γ-cyclodextrin is dispersed in 5 to 10 parts by mass of water, and completely dissolved by stirring the mixture under the applied heat of 60 to 80° C. A predetermined amount of myricitrin is then added to the solution. At the maintained temperature of 60 to 80° C., the alkali is added in a proportion of about 0.5 to 5 mass % while gently stirring the solution. The solution is further stirred for 0.1 to 2 hours at the adjusted pH of preferably 7 to 10, further preferably 7 to 8. This is followed by addition of acids to adjust the pH to preferably 4 to 6. The myricitrin composition thus prepared may be directly used as the solution, or may be dried and formed into a powder using methods such as freeze-drying, spray-drying, reduced-pressure drying, and drum drying.

### (c) Mixing and Pulverizing Method

γ-Cyclodextrin is added to myricitrin in a proportion of 1 to 7 moles per mole of the myricitrin. These are mixed in a solid state by being crushed with a device such as a high-speed pulverizer.

The myricitrin and γ-cyclodextrin used for the production of the inclusion product (myricitrin composition) may be mixed in a proportion of typically 1 to 7 moles of γ-cyclodextrin per mole of myricitrin, regardless of the mixing method used. The preferred proportion is 1 to 6 moles, more preferably 1 to 5 moles, further preferably 2 to 5 moles, particularly preferably 2 to 4 moles.

The myricitrin inclusion product of γ-cyclodextrin (myricitrin composition) obtained in the methods (a) to (c) is characterized by the greatly improved (increased) solubility in water of myricitrin compared to the myricitrin itself. The solubility (in terms of myricitrin) of the myricitrin composition for water is 90 times or higher, preferably 100 times or higher, more preferably 150 times or higher, further preferably 180 times or higher, particularly preferably 200 times or higher than the solubility of the myricitrin itself for water under the condition shaking for 40 hours at 25° C. The upper limit is not particularly limited, and is about 300 times based on the Experiment Examples below.

Accordingly, the “readily water-soluble myricitrin composition” used in the present invention is a myricitrin composition whose solubility in water as measured in terms of myricitrin by being added to water and shaken at 25° C. for 40 hours is 90 times or higher, preferably 100 times or higher, more preferably 150 times or higher, further preferably 180 times or higher, particularly preferably 200 times or higher than the solubility of the myricitrin itself (non-inclusion product) measured under the same conditions. The upper limit is not particularly limited, and is about 300 times based on the Experiment Examples below.

In terms of the absolute amount of myricitrin, the “readily water-soluble myricitrin composition” is a myricitrin composition whose solubility in water as measured in terms of myricitrin by being shaken and dissolved at 25° C. for 40 hours is 10 mg/ml or more, preferably 13 mg/ml or more, more preferably 18 mg/ml or more, further preferably 20 mg/ml or more, particularly preferably 23 mg/ml or more. The upper limit is not particularly limited, and is about 30 mg/ml based on the Examples below.

With the improved solubility in water, the readily water-soluble myricitrin composition of the present invention can be stably dissolved in large amounts in a water-soluble edible composition (described later), and an edible composition dissolving high concentrations of myricitrin can be prepared. The stable dissolution is the characteristic effect obtained with the use of the readily water-soluble myricitrin composition of the present invention, as will be described in Experiment Example 2. The readily water-soluble myricitrin composition of the present invention can thus be stably dissolved without causing the myricitrin to deposit, regardless of the pH (acidic to alkaline) or the temperature (for example, low temperature to 60° C.) of the edible composition. Further, with the readily water-soluble myricitrin composition of the present invention, the myricitrin degradation can be significantly suppressed even when preserved by being dissolved in, for example, an acidic water-soluble composition. The readily water-soluble myricitrin composition of the present invention can thus be used to prepare a water-soluble edible composition having superior myricitrin preservation stability.

Further, because of the high solubility in water, the readily water-soluble myricitrin composition has advantages over myricitrin compositions mixed without being included. Specifically, the readily water-soluble myricitrin composition melts more easily in the mouth even when taken orally in the form of a solid, a granule, or a powder; and thus causes less grittiness in the mouth, and is easier to ingest.

### (2) Edible Composition Containing Readily Water-Soluble Myricitrin Composition

As described above, the myricitrin composition of the present invention has improved solubility in water, and can thus be stably mixed in large amounts in a water-soluble composition, making it possible to prepare an edible composition dissolving high concentrations of myricitrin.

The edible composition of the present invention encompasses liquid or semiliquid edible compositions compatible with water and dissolving the readily water-soluble myricitrin composition of the present invention. Preferably, the edible composition of the present invention is a composition that dissolves myricitrin in a proportion of 0.01 mass % or more (0.1 mg/ml), preferably 0.012 mass % or more (0.12 mg/ml) under the condition at 25° C. The upper limit solubility of the myricitrin itself in water under the acidic condition at 25° C. is 0.01153 mass % (0.1153 mg/ml), as will be described in Experiment Example 1.

The liquid or semiliquid edible composition of the present invention is a composition that is obtained by dissolving the readily water-soluble myricitrin composition of the present invention in water or aqueous alcohol without causing the composition to deposit. The myricitrin content is not particularly limited, so long as this is satisfied. For example, the upper limit solubility in water under the acidic condition at 25° C. may be 3 mass % (30 mg/ml), based on the Experiment Examples below.

Here, “under the condition at 25° C.” as used herein is not intended to limit the temperature of the composition of interest, but is rather a reference water temperature used to evaluate the solubility in water of the composition of the present invention.

The liquid or semiliquid edible composition of the present invention may contain a solvent that is 100% water, or may be an aqueous alcohol (preferably, aqueous ethanol) that contains no greater than 25 mass % of alcohols such as ethanol as the solvent.

The edible composition of the present invention encompasses edible compositions of a solid form obtained by solidifying the liquid or semiliquid edible composition. The solidification process is not particularly limited, and may be performed by using ordinary solidifying means, such as cooling, freezing, heating, and drying (including freeze-drying, and spray-drying). The edible composition of the present invention may be any edible composition solidified in this manner.

Examples of the edible composition of the present invention include oral medicine (drink, syrup, etc.), quasi drug (mouth wash, etc.), health food (drink, tablet, etc.), food with health claims (e.g., food with nutrient function claims, food for specified health uses, etc.), and food and drink. Examples of food and drink include, but are not limited to, milk beverages, Lactobacillus beverages, fruit juice-containing soft drinks, soft drinks, carbonated beverages, fruit juice beverages, vegetable drinks, vegetable•fruit drinks, alcoholic beverages, powdered beverages, concentrated drinks for dilution with water, coffee drinks, shiruko (sweet red-bean soup with pieces of rice cake) beverage, black tea beverages, green tea beverages, barley tea beverages, oolong tea beverages, hatomugi (adlay) tea beverages, soba (buckwheatk) tea beverages, Dattan soba (Tartary buckwheat) tea beverages, puer tea beverages, and other such beverages; custard pudding, milk pudding, souffle pudding, fruit juice-containing pudding, and other such puddings; jellies, Bavarian cream, yogurt, and other such desserts; ice cream, ice milk, lacto-ice, milk ice cream, fruit juice-containing ice cream, soft serve ice cream, ice lollipops, sherbet, and other such frozen concoctions; chewing gum, bubble gum, and other such gums (stick gum and sugar-coated gum granules); marble chocolate and other such coated chocolates, as well as strawberry chocolate, blueberry chocolate, melon chocolate, and other flavored chocolates, and other such chocolates; Ramune (tablet candies); hard candy (including bonbons, butterballs, and marbles), soft candy (including caramel, nougat, gummy candy, and marshmallow), drops, taffy, and other such candies; hard biscuits, cookies, okaki (cracker made from glutinous rice), senbei (cracker made from regular rice), and other such baked snacks (hereinafter, “snacks”); miso soup, sumashi jiru (a clear soup), consomme soup, potage soup, and other such soups; asazuke (lightly-pickled vegetables), soy sauce pickles, salt pickles, miso pickles, kasuzuke (fish or vegetables pickled in sake lees), kojizuke (rice malt pickles), nukazuke (vegetables pickled in brine and fermented rice bran), vinegar pickles, mustard pickles, moromizuke (unrefined miso pickles), pickled plum, fukujinzuke (sliced vegetables pickled in liquid preparation containing soy sauce and dyed red), shibazuke (assorted vegetables hashed and pickled in salt), pickled ginger, plum vinegar pickles, and other such pickles; vinaigrette dressings, non-oil dressings, ketchup, gravy, sauce, and other such sauces; strawberry jam, blueberry jam, marmalade, apple jam, apricot jam, preserves, and other such jams; red wine and other such fruit wines; candied cherries, apricots, apples, strawberries, peaches, and other such processed fruits; ham, sausage, roast pork, and other such processed meats; fish meat ham, fish meat sausage, ground fish meat, boiled fish paste, chikuwa (tubular fish cakes), hanpen (a cake of pounded fish), satsumaage (fried fish cakes), datemaki (rolled omelets mixed fish paste), whale bacon, and other ground marine products; konjac, tofu, and other such processed farm products; butter, margarine, cheese, whip cream, and other such dairy-fatty products; udon noodles, hiyamugi (cold wheat noodles), somen (thin wheat noodles), soba, Chinese soba noodles, spaghetti, macaroni, rice noodles, harusame (thin noodles made from bean starch), wonton, and other such pastas; as well as various types of side dishes and processed foods such as wheat gluten bread and denbu (mashed and seasoned fish).

The readily water-soluble myricitrin composition of the present invention has greatly improved solubility in water, and can thus provide effects particularly when prepared by being added to an aqueous transparent edible composition. Preferably, such liquid or semiliquid edible compositions are, for example, products that require transparency, such as drinks, jelly-like food, jams, fruit sauces, or beverages. Preferred examples of solid-form edible compositions include products that require transparency, such as hard candies and jelly food, and products dissolved in water or warm water before consumed, such as powdered beverages, solid soups, and powdered soups. The liquid property (pH) is not particularly limited, and is, for example, 2 to 7, preferably 2.5 to 6.5.

Another advantage of the readily water-soluble myricitrin composition of the present invention owning to the greatly improved solubility in water is that it does not deposit even when added to an aqueous edible composition in high concentration. Examples of edible compositions suited in this regard include coating chocolates, syrups for sugar coating (sugar solution), candies, frozen concoctions, chocolates, and gummy candies. Other examples include tofu, konjac, seaweeds (these are liquids or semiliquids during manufacture, but are solidified into solid-form edible compositions by, for example, cooling, freezing, heating, or drying).

Adding the myricitrin composition of the present invention to the edible composition does not require a dedicated step. For example, the myricitrin composition may be appropriately added with the raw material in the early stages of the food and drink manufacturing steps, or may be added in the middle or later stages of the manufacturing steps. The addition method is not particularly limited either, and may be selected from ordinary methods such as kneading, dissolving, dipping, dispersing, spraying, and coating, according to the type and properties of the edible compositions.

### (3) Water Solubility Improving Method for Myricitrin

The present invention also provides a method for improving the solubility of myricitrin in water. The method can be realized by including myricitrin in γ-cyclodextrin in a proportion of 1 to 7 moles of γ-cyclodextrin per mole of myricitrin, as described above. The proportion of γ-cyclodextrin per mole of myricitrin is preferably 1 to 6 moles, more preferably 1 to 5 moles, further preferably 2 to 5 moles, particularly preferably 2 to 4 moles.

The inclusion of the myricitrin in the γ-cyclodextrin may be performed in the same manner as in the readily water-soluble myricitrin composition producing method described in section (1) above.

The myricitrin composition obtained this way has greatly improved solubility in water compared to the non-included myricitrin. The solubility of the myricitrin composition in water in terms of myricitrin is improved 90 times or more, preferably 100 times or more, more preferably 150 times or more, further preferably 180 times or more, still further preferably 200 times or more from the solubility of the myricitrin itself in water under the condition shaking for 40 hours at 25° C. The upper limit is not particularly limited, and is about 300 times based on the Examples below.

### (4) Color Deterioration Suppressing Agent and Color Deterioration Suppressing Method

### (4-1) Color Deterioration Suppressing Agent

The color deterioration suppressing agent of the present invention contains the readily water-soluble myricitrin composition of the present invention as the active ingredient.

The color deterioration suppressing agent of the present invention may contain the readily water-soluble myricitrin composition as the sole component, or may also contain other components such as diluents, carriers, and other such additives, provided that the readily water-soluble myricitrin composition is contained.

The diluents and carriers are not particularly limited, as long as they do not interfere with the effects of the present invention. Examples include sugars such as sucrose, glucose, dextrin, starches, trehalose, lactose, maltose, corn syrup, and liquid sugar; alcohols such as ethanol, propylene glycol, and glycerine; sugar alcohols such as sorbitol, mannitol, xylitol, erythritol, and maltitol; polysaccharides such as gum arabic, gum ghatti, xanthan gum, carrageenan, guar gum, gellan gum, and celluloses; and water. Examples of additives include chelating agents and other auxiliary agents, flavorings, spice extracts, antiseptics, preservatives, pH adjusters, stabilizers, and oxidation inhibitors.

A wide range of compounds used as food additives can be used as the oxidation inhibitors used as additives. Examples include, but are not limited to, ascorbic acids such as L-ascorbic acid and sodium L-ascorbate; ascorbic acid esters such as L-ascorbyl stearate, and L-ascorbyl palmitate; erythorbic acids such as erythorbic acid and salts thereof (e.g., sodium erythorbate); sulfites such as sodium sulfite, sodium hyposulfite, sodium pyrosulfite, and potassium pyrosulfite; tocopherols such as α-tocopherol and mix tocopherol; dibutylhydroxytoluene (BHT), butylhydroxyanisole (BHA); ethylenediaminetetraacetic acids such as calcium disodium ethylenediaminetetraacetate, and disodium ethylenediaminetetraacetate; gallic acids such as gallic acid and propyl gallate; citric acids such as citric acid and isopropyl citrate; sulfur dioxide; and various plant extracts such as hollyhock flower extract, Aspergillus terreus extract, licorice oil extract, clove extract, essential oil-removed fennel extract, horseradish extract, sage extract, dropwort extract, tea extract, tempeh extract, coffee bean extract, sunflower seed extract, pimento extract, grape seed extract, blueberry leaf extract, propolis extract, Hego(Cyathea fauriei)-Ginkgo(Ginkgo biloba) leaf extract, pepper extract, garden balsam extract, eucalyptus leaf extract, gentian root extract, enzymatically decomposed apple extract, rapeseed oil extract, rice bran oil extract, enzymatically decomposed rice bran, rutin extract (red bean whole plant, Styphnolobium japonicum, soba whole plant extract), and rosemary extract. Other examples include γ-oryzanol, ellagic acid, guaiac gum, sesamolin, sesamol, Melaleuca oil, amino acid-sugar reaction product, chlorogenic acid, phytic acid, ferulic acid, tritrienol, rapeseed oil extract, dokudami (Houttuynia cordata) extract, sesame oil unsaponifiable, hesperetin, catechin, morin, enzyme-treated rutin, quercetin, enzymatically decomposed rutin (isoquercitrin), and enzyme-treated isoquercitrin.

For convenience in use, it is preferable that the color deterioration suppressing agent prepared with the diluent, carrier, or additive contain the readily water-soluble myricitrin composition (as a dried product) in 0.01 to 50 mass %, preferably 0.03 to 30 mass %, more preferably 0.3 to 20 mass % in terms of the myricitrin amount.

The form of the color deterioration suppressing agent of the present invention is not particularly limited, and the color deterioration suppressing agent may be prepared in any form, including, for example, a solid form such as a powder, a granule, and a tablet; a solution form such as a liquid and an emulsion; and a semi-solid form such as a paste.

The colorant of the color deterioration suppressing agent of the present invention includes a wide range of colorants, both synthetic and natural. Synthetic colorants may be synthetic colorants, including tar colorants such as Food Red No. 2, Food Red No. 3, Food Red No. 40, Food Red No. 102, Food Red No. 104, Food Red No. 105, Food Red No. 106, Food Yellow No. 4, Food Yellow No. 5, Food Blue No. 1, Food Blue No. 2, and Food Green No. 3; inorganic pigments such as ferric oxide and titanium dioxide; natural colorant derivatives such as sodium norbixinate, potassium norbixinate, copper chlorophyll, sodium copper chlorophyllin, and potassium copper chlorophyllin; and synthetic natural colorants such as β-carotene, riboflavin, riboflavin butyrate ester, and 5′-riboflavin phosphate ester sodium.

Examples of natural colorants include carotenoid-based colorants such as annatto colorant, gardenia yellow colorant, Dunaliella carotene, carrot carotene, palm oil carotene, marigold colorant, tomato colorant, and paprika colorant; anthocyanin-based colorants such as red cabbage colorant, red radish colorant, perilla colorant, hibiscus colorant, grape fruit juice colorant, grape skin colorant, purple sweet potato colorant, purple corn colorant, elderberry colorant, and boysenberry; flavonoid-based colorant s such as cacao colorant, kaoliang colorant, rosewood colorant, onion colorant, tamarind colorant, persimmon colorant, carob colorant, sweetroot colorant, sappanwood colorant, safflower red colorant, and safflower yellow colorant; quinone-based colorants such as madder colorant, cochineal colorant, shikon colorant (root extract from Lithospermum erythrorhizon), and lac colorant; porphyrin-based colorants such as chlorophyllin, chlorophyll, and spirulina colorant; diketone-based colorants such as turmeric colorant; betacyanin-based colorants such as beet red colorant; and azaphilone-based colorants such as Monascus colorant. Other examples include Monascus yellow colorant, caramel, gardenia blue, Gardenia red, gold, silver, and aluminum-based colorants. Preferably, the color deterioration suppressing agent of the present invention may be used for natural colorants. More preferably, the color deterioration suppressing agent has a wide range of applications in products containing the natural colorants exemplified above, specifically, natural colorants such as carotenoid-based colorants, anthocyanin-based colorants, flavonoid-based colorants, quinone-based colorants, azaphilone-based colorants, and gardenia blue colorant. The color deterioration suppressing agent is thus useful in suppressing or preventing the fading of these colorants.

The specific products (colored products) to which the color deterioration suppressing agent of the present invention are applicable are not particularly limited, as long as the products contain the colorants above. Examples include color preparations, food and drink (food products), cosmetics, drugs, quasi drugs, and feeds, preferably color preparations and food and drink (food products). Use of the color deterioration suppressing agent of the invention for such products (colored products) is described in the following section (4-2).

### (4-2) Colored Products Containing the Color Deterioration Suppressing Agent

The present invention provides a colored product that uses the readily water-soluble myricitrin composition of the present invention as the color deterioration suppressing agent. By containing the composition, the colored product can have the effect of significantly suppressing the colorant fading phenomenon, specifically the fading phenomenon resulting from exposure to light.

As used herein, the term “colored” refers not only to colorants imparted to a product by intentionally adding a color, but to a broad range of colorants that originate in the colorants naturally present in the material of food and drink products, such as, for example, in fruit juice and vegetable juice. Further, the “colored product” as used herein encompasses a variety of products imparted with colorants, particularly with the natural colorants exemplified above. Specific examples include colorant preparations, colorant-containing colored food and drink, colorant-containing colored cosmetics, colorant-containing colored drugs, colorant-containing colored quasi drugs, and colorant-containing colored feeds.

The colorant preparation of the present invention may be one that contains one or more of the synthetic or natural colorants above in addition to the readily water-soluble myricitrin composition of the present invention, preferably, colorant preparations containing one or more natural colorants. The preferred colorant preparation is one that contains at least one natural colorant selected from the group of various colorants that belong to carotenoid-based colorants, anthocyanin-based colorants, flavonoid-based colorants, quinone-based colorants, azaphilone-based colorants, and gardenia blue colorant.

The proportion of the readily water-soluble myricitrin composition mixed in the colorant preparation is not particularly limited, as long as the effects of the present invention are obtained. For example, the myricitrin composition may be contained in the colorant preparation in a proportion of 0.03 mass % or more, preferably 0.03 to 30 mass %, more preferably 0.3 to 20 mass % in terms of the myricitrin amount.

The colorant preparation of the present invention includes at least a colorant and the readily water-soluble myricitrin composition, and may additionally include an oxidation inhibitor, a chelating agent, a flavoring or a spice extract, an antiseptic, a preservative, a pH adjuster, or a stabilizer, as required.

The colorant preparation of the present invention may be produced by methods commonly used for the preparation of various colorant preparations, except for mixing the readily water-soluble myricitrin composition in any of the production steps. The method for mixing the readily water-soluble myricitrin composition, or the order in which the components are mixed are not particularly limited. However, considering that the colorant is under the influence of heat and light to various extents, it is preferable that the composition be mixed with other materials at early stages of the colorant preparation production steps, preferably before the heat-treatment step or before exposure to light.

The food and drink of the present invention are not particularly limited, as long as a colorant is imparted, preferably based on the natural colorant. For example, the various foods and drinks exemplified in section (2) Edible Composition Containing Readily Water-Soluble Myricitrin Composition may be used. The preferred food and drink are drinks and jellies.

The food and drink of the present invention can be produced according to methods commonly used for the production of various foods and drinks, except for mixing the readily water-soluble myricitrin composition in any of the production steps. The method for mixing the readily water-soluble myricitrin composition, or the order in which the components are mixed are not particularly limited. However, considering that the color is under the influence of heat and light to various extents, it is preferable that the readily water-soluble myricitrin composition be mixed at early stages of the production steps, preferably before the heat-treatment step or before exposure to light.

The amount of the color deterioration suppressing agent of the present invention added to various colored products such as food and drink, cosmetics, drugs, quasi drugs, and feeds is not particularly limited, provided that the color fading phenomenon can be prevented. Various amounts can be appropriately selected and decided taking into consideration such factors as the type and the content of the colorant contained in the colored product, the type and the intended use of the product, and the type of the components contained in the product. For example, when the colored product is adjusted in such a manner that the colorant to be suppressed from fading has an absorbance of 0.05 to 1 (color valency (E^{10%}_{1cm})=0.005 to 0.1) at the maximum absorption wavelength, the color deterioration suppressing agent (readily water-soluble myricitrin composition) is preferably mixed with the colored product in an amount of at least 3 ppm, for example, in a range of 3 to 1000 ppm, preferably 3 to 300 ppm in terms of the isoquercitrin amount. Further preferably, the color deterioration suppressing agent (readily water-soluble myricitrin composition) is mixed with the colored product having the above color valency (E^{10%}_{1cm}) in an amount of at least 0.03 mass % or more, preferably 0.3 to 30 mass %, more preferably 0.3 to 20 mass % in terms of the myricitrin amount.

The color valency means the concentration of the color in a colored material (colored solution), and is generally represented by the absorbance value of a 10 w/v % solution (E^{10%}_{1cm}) converted from the measured absorbance of the colored material (colored solution) in the visible range at the maximum absorption wavelength. Specifically, the color valency (E^{10%}_{1cm}) can be obtained by first adjusting the concentration of the measured colored material (colored solution) to confine the absorbance within a 0.3 to 0.7 range, and then measuring the absorbance at the maximum absorption wavelength using a cell with a layer length of 1 cm. The measured absorbance is then converted to an absorbance for a 10 w/v % concentration of the colored material (colored solution) (see the Specifications and Standards for Food Additives, 8th ed., 17. Color Valency Measurement Method).

### (4-3) Fading Suppressing Method

The present invention also provides a method for suppressing the fading of a colorant or various compositions containing a colorant.

The colorant of the present invention is any of the synthetic and natural colorants above, preferably any of the natural colorants above, more preferably any of the carotenoid-based colorants, anthocyanin-based colorants, flavonoid-based colorants, quinone-based colorants, azaphilone-based colorants, and gardenia blue. Specifically, the fading suppressing method of the present invention excels in suppressing the fading phenomenon caused by irradiation of the colorant with light (excels in lightfastness), as will be described later in the Experiment Examples.

As used herein, various compositions containing a colorant (colorant-containing compositions) means a wide range of compositions that contain a colorant, preferably a natural colorant. Specific examples are various colored products, such as the colorant preparations, food and drink, cosmetics, drugs, quasi drugs, and feeds exemplified above.

The present invention can be effected by having the colorant or the colorant-containing composition coexist with the readily water-soluble myricitrin composition or the color deterioration suppressing agent of the present invention. The coexisting form of these components is not particularly limited, as long as these are present in contact with each other. For example, such a coexisting form may be obtained by mixing the colorant or the colorant-containing composition with the readily water-soluble myricitrin composition that has the fading suppressing effect. For example, such a coexisting form may be obtained by mixing the colorant or the colorant-containing composition with the readily water-soluble isoquercitrin composition that has the color deterioration suppressing effect. For example, when the colorant-containing composition is a colorant preparation or a food or drink, the coexisting state can be achieved by mixing the readily water-soluble myricitrin composition as one of the material components during the production of the colorant preparation or the food or drink. This is also possible in other colored products such as cosmetics, drugs, quasi drugs, and feeds.

The proportion of the readily water-soluble myricitrin composition used for the colorant or the colorant-containing composition is not particularly limited as long as the effects of the present invention can be obtained, and may be appropriately adjusted according to the type of the colorant of interest. The proportion of the readily water-soluble myricitrin composition used for the colorant-containing composition is not particularly limited, and may be at least 0.03 mass % or more, preferably 0.3 to 30 mass %, more preferably 0.3 to 20 mass % in terms of the myricitrin amount, when the colorant-containing composition is adjusted in such a manner that the colorant to be suppressed from fading has an absorbance of 0.05 to 1 (color valency (E^{10%}_{1cm})=0.005 to 0.1) at the maximum absorption wavelength.

The fading suppressing method of the present invention can significantly suppress the fading of the colorant or the colorant-containing composition. The fading suppressing method of the present invention particularly excels in suppressing fading that occurs as a result of the photoirradiation of the carotenoid-based colorant, anthocyanin-based colorant, flavonoid-based colorant, quinone-based colorant, azaphilone-based colorant, and gardenia blue, or of the compositions containing these colorants, and can render the colorant or the colorant-containing composition photofading-resistant (lightfast).

As used herein, “photofading-resistant” refers to the property that resists fading even under the influence of sunlight or artificial light (such as fluorescent light). Specifically, the term “photofading-resistant” refers to the property to significantly suppress the fading of the colorant or the colorant-containing composition placed under light (sunlight, fluorescent light, etc.) present in normal storage conditions, compared to colorants or colorant-containing compositions that do not contain the color deterioration suppressing agent. Examples of such conditions include exposing the colorant or the colorant-containing composition to sunlight for 5 minutes to several hours, or to fluorescent light for 1 day to 6 months.

### (5) Flavor Deterioration Suppressing Agent and Flavor Deterioration Suppressing Method

### (5-1) Flavor Deterioration Suppressing Agent

The flavor deterioration suppressing agent of the present invention contains the readily water-soluble myricitrin composition of the present invention as the active ingredient.

The flavor deterioration suppressing agent of the present invention may contain the readily water-soluble myricitrin composition as the sole component, or may also contain other components such as diluents, carriers, and other such additives, provided that the myricitrin composition is contained.

The diluents and carriers are not particularly limited, as long as they do not interfere with the effects of the present invention. Examples include sugars such as sucrose, glucose, dextrin, starches, trehalose, lactose, maltose, corn syrup, and liquid sugar; alcohols such as ethanol, propylene glycol, and glycerine; sugar alcohols such as sorbitol, mannitol, xylitol, erythritol, and maltitol; polysaccharides such as gum arabic, gum ghatti, xanthan gum, carrageenan, guar gum, gellan gum, and celluloses; and water. Examples of additives include oxidation inhibitors, chelating agents and other auxiliary agents, flavorings, spice extracts, antiseptics, preservatives, pH adjusters, and stabilizers.

A wide range of compounds used as food additives can be used as the oxidation inhibitors used as additives. Examples include, but are not limited to, ascorbic acids such as L-ascorbic acid and sodium L-ascorbate; ascorbic acid esters such as L-ascorbyl stearate, and L-ascorbyl palmitate; erythorbic acids such as erythorbic acid and salts thereof (e.g., sodium erythorbate); sulfites such as sodium sulfite, sodium hyposulfite, sodium pyrosulfite, and potassium pyrosulfite; tocopherols such as α-tocopherol and mix tocopherol; dibutylhydroxytoluene (BHT), butylhydroxyanisole (BHA); ethylenediaminetetraacetic acids such as calcium disodium ethylenediaminetetraacetate, and disodium ethylenediaminetetraacetate; gallic acids such as gallic acid and propyl gallate; citric acids such as citric acid and isopropyl citrate; sulfur dioxide; and various plant extracts such as hollyhock flower extract, Aspergillus terreus extract, licorice oil extract, clove extract, essential oil-removed fennel extract, horseradish extract, sage extract, dropwort extract, tea extract, tempeh extract, coffee bean extract, sunflower seed extract, pimento extract, grape seed extract, blueberry leaf extract, propolis extract, Hego(Cyathea fauriei)-Ginkgo(Ginkgo biloba) leaf extract, pepper extract, garden balsam extract, eucalyptus leaf extract, gentian root extract, enzymatically decomposed apple extract, rapeseed oil extract, rice bran oil extract, enzymatically decomposed rice bran, rutin extract (red bean whole plant, Styphnolobium japonicum, soba whole plant extract), and rosemary extract. Other examples include roryzanol, ellagic acid, guaiac gum, sesamolin, sesamol, Melaleuca oil, amino acid-sugar reaction product, chlorogenic acid, phytic acid, ferulic acid, tocotrienol, rapeseed oil extract, dokudami (Houttuynia cordata) extract, sesame oil unsaponifiable, hesperetin, catechin, morin, enzyme-treated rutin, quercetin, enzymatically decomposed rutin (isoquercitrin), and enzyme-treated isoquercitrin.

For convenience in use, it is preferable that the flavor deterioration suppressing agent prepared with the diluent, carrier, or additive contain the readily water-soluble myricitrin composition in at least 0.03 mass % or more, preferably 0.03 to 30 mass %, more preferably 0.3 to 20 mass % in terms of the myricitrin amount.

The form of the flavor deterioration suppressing agent of the present invention is not particularly limited, and the flavor deterioration suppressing agent may be prepared in any form, comprising, for example, a solid form such as a powder, a granule, and a tablet; a solution form such as a liquid and an emulsion; and a semi-solid form such as a paste.

The flavor component of the flavor deterioration suppressing agent of the present invention encompasses flavor components that form flavorings, which may be natural flavorings (plant natural flavorings, animal natural flavorings), or synthetic flavorings.

Specific examples of the flavor components include those forming citrus-based flavorings such as orange, lemon, and grapefruit; fruit-based flavorings such as apple, grape, peach, banana, and pineapple; milk-based flavorings such as milk, butter, cheese, and yogurt; vanilla-based flavorings; tea-based flavorings such as black tea and green tea; coffee-based flavorings; mint-based flavorings; spice-based flavorings such as herb, pepper, and wasabi; nut-based flavorings; meat-based flavorings such as beef, pork, and chicken; marine products flavorings such as fish and shellfish, and crustaceans; Western liquor-based flavorings such as wine, whisky, and brandy; flower-based flavorings such as rose, lavender, and jasmine; vegetable-based flavorings such as onion, garlic, and cabbage; flavorings for cooking such as meat dish, seafood, and vegetable cuisine; and other such flavorings. The preferred flavor component is one that forms citrus-based flavorings and milk-based flavorings. In general, flavorings cannot be reproduced from a single scent component, and multiple scent components are used. For example, a flavoring is prepared by blending a variety of scent components with the main component source substances that characterize different types of scent. The source substances for different types of scent are known, and can be prepared by a person with ordinary skill in the art (see, for example, the reference Kaori no Sougou Jiten, Japan Flavor & Fragrance Materials Association, ed., Asakura Publishing Co., Ltd., Dec. 10, 1998).

As will be described in the Experiment Examples, the scent deterioration suppressing agent of the present invention has been shown to effectively suppress the flavor deterioration phenomenon caused by light or heat in food products, comprising food and drink containing citrus-based flavorings, and food and drink containing milk-based flavorings (lightfastness and heat resistance). Thus, the flavor deterioration suppressing agent of the present invention can be used in a wide range of products (scented products) that contain various flavor components, preferably flavor components that form citrus-based flavorings or milk-based flavorings. The flavor deterioration suppressing agent of the present invention is therefore useful in suppressing or preventing flavor deterioration in these products.

The flavor deterioration suppressing agent of the present invention can be used in a wide range of products (flavor-containing products, scented products, flavored products; hereinafter, collectively referred to as “scented products”) for the suppression of flavor deterioration, particularly the flavor deterioration caused by light or heat. Examples of such scented products include flavorings, food and drink, cosmetics, drugs, quasi drugs, and feeds, preferably flavorings, food and drink, and cosmetics. The preferred form is an aqueous form, specifically solutions such as drinks, lotions, and liquid formulation, particularly aqueous solutions.

The flavor deterioration suppressing agent of the present invention can prevent flavor deterioration by being added and mixed with products that have the flavors imparted by flavor components such as flavorings, or with products that naturally contain flavor components. Use of the flavor deterioration suppressing agent of the invention for such scented products will be described in sections (5-2) and (5-3) below.

### (5-2) Scented Products Containing Flavor Deterioration Suppressing Agent

The present invention provides a scented product that contains the readily water-soluble myricitrin composition as the flavor deterioration suppressing agent. By containing the readily water-soluble myricitrin composition, the scented product has the effect to significantly suppress flavor deterioration phenomena, particularly the flavor deterioration phenomenon caused when exposed to light or heat.

As used herein, the term “scented” refers not only to scent imparted by intentionally adding a flavor component (flavoring) to the product, but a broad range of flavors that originate in the flavor components naturally present in the material of food and drink products, such as in, for example, fruit juice and vegetable juice. Further, the “scented product” as used herein encompasses a variety of products scented with the flavor components, particularly with the flavorings exemplified above. Specific examples include flavorings themselves, flavoring preparations, food and drink, cosmetics, drugs, quasi drugs, and feeds.

Examples of preferred products include flavoring; food and drink claimed to have a commercial value in giving a flavor sensation in the mouth; cosmetics such as lipsticks and lip balms; oral pharmaceutical preparations; quasi drugs such as toothpastes, mouth washes, and mouth odor preventive agents. Flavorings and food and drink are more preferred.

The flavoring of the present invention may be any flavoring, including natural flavorings (plant natural flavorings, animal natural flavorings) and synthetic flavorings, both in simple and preparation forms, regardless of the producing method and form (water-soluble flavorings, oily flavorings, emulsion flavorings, powder flavorings), and whether it is used for food or cosmetics.

Preferably, the flavoring is a citrus-based flavoring such as orange, lemon, and grapefruit flavorings, or a milk-based flavoring such as milk, butter, cheese, and yogurt flavorings.

The flavoring may be categorized according to the intended use, as follows. Beverage flavorings used for carbonated beverages, fruit drinks, tea-/coffee-based drinks, milk beverages, Lactobacillus beverages, beverages with function claims, and other such beverages; sweets flavorings used for frozen concoctions, candies or desserts, chewing gums, baked snacks, and other such sweets; flavorings for dairy or fatty products such as yogurt, butter or margarine, and cheese; soup flavorings; flavor-enhancing flavorings used for products such as miso, soy sauce, sauce, gravy, and dressing; flavorings for processed meat; flavorings for processed fishery products; flavorings for cooked food; food flavorings such as frozen food flavorings; cigarette flavorings; flavorings for mouth products; drug flavorings; feed flavorings; and flavorings for industrial use.

The proportion of the flavor deterioration suppressing agent mixed in the flavoring is not particularly limited, as long as the effects of the present invention can be obtained. For flavorings generally used in 0.05 to 0.2 mass % for the flavored product, the preferred proportion of the readily water-soluble myricitrin composition for the flavoring is at least 0.03 mass %, preferably 0.03 to 30 mass %, more preferably 0.3 to 20 mass % in terms of the myricitrin amount. Although the upper limit is not limited in terms of the effect of the present invention, the proportion for liquid flavorings is, for example, preferably 10 mass % or less, because the excess addition may be detrimental to the natural flavor of the flavored product, or may cause the insoluble matter to deposit.

The flavoring obtained in this manner can be provided as a flavoring that does not undergo flavor deterioration during the production steps or distribution or in long storage, and that is resistant to light, heat, or other factors that promote deterioration. Further, the flavoring can not only impart a desired flavor to various products such as food and drink, cosmetics, drugs, quasi drugs, and feeds, but significantly prevent flavor deterioration caused by factors such as heat, light, and oxygen, particularly flavor deterioration caused by heat, in products such as food and drink, cosmetics, drugs, quasi drugs, and feeds.

The flavoring of the present invention can be produced according to methods commonly used for flavorings, except for mixing the readily water-soluble myricitrin composition in any of the production steps. The method for mixing the readily water-soluble myricitrin composition, or the order in which the components are mixed are not particularly limited. However, considering that the flavoring is under the influence of heat and light to various extents, it is preferable that the readily water-soluble myricitrin composition be mixed with various materials in the early stages of the flavoring production steps, preferably before the heat-treatment step or before exposure to light.

The food and drink of the present invention are not particularly limited, as long as they are scented, preferably by containing the flavoring (flavor component). More preferably, the food and drink are those having citrus-based or milk-based scent. Examples of the food and drink include milk beverages, Lactobacillus beverages, fruit juice-containing soft drinks, soft drinks, carbonated beverages, fruit juice beverages, vegetable drinks, vegetable/fruit drinks, alcoholic beverage, powdered beverages, concentrated drinks for dilution with water, coffee drinks, shiruko (sweet red-bean soup with pieces of rice cake) beverage, black tea beverages, green tea beverages, barley tea beverages, oolong tea beverages, hatomugi (adlay) tea beverages, soba (buckwheatk) tea beverages, Dattan soba (Tartary buckwheat) tea beverages, puer tea beverages, red tea beverages, green tea beverages, barley tea beverages, and other such beverages; custard pudding, milk pudding, souffle pudding, fruit juice-containing pudding, and other such puddings; jellies, Bavarian cream, yogurt, and other such desserts; ice cream, ice milk, lacto-ice, milk ice cream, fruit juice-containing ice cream, soft serve ice cream, ice lollipops, sherbet, and other such frozen concoctions; chewing gum, bubble gum, and other such gums (stick gum and sugar-coated gum granules); marble chocolate and other such coated chocolates, as well as strawberry chocolate, blueberry chocolate, melon chocolate, and other flavored chocolates, and other such chocolates; hard candy (including bonbons, butterballs, and marbles), soft candy (including caramel, nougat, gummy candy, and marshmallow), drops, taffy, and other such candies; hard biscuits, cookies, okaki (cracker made from glutinous rice), senbei (cracker made from regular rice), and other such baked snacks (hereinafter, “snacks”); miso soup, sumashi jiru (a clear soup), consomme soup, potage soup, and other such soups; asazuke (lightly-pickled vegetables), soy sauce pickles, salt pickles, miso pickles, kasuzuke (fish or vegetables pickled in sake lees), kojizuke (rice malt pickles), nukazuke (vegetables pickled in brine and fermented rice bran), vinegar pickles, mustard pickles, moromizuke (unrefined miso pickles), pickled plum, fukujinzuke (sliced vegetables pickled in liquid preparation containing soy sauce and dyed red), shibazuke (assorted vegetables hashed and pickled in salt), pickled ginger, plum vinegar pickles, and other such pickles; vinaigrette dressings, non-oil dressings, ketchup, gravy, sauce, and other such sauces; strawberry jam, blueberry jam, marmalade, apple jam, apricot jam, preserves, and other such jams; red wine and other such fruit wines; candied cherries, apricots, apples, strawberries, peaches, and other such processed fruits; ham, sausage, roast pork, and other such processed meats; fish meat ham, fish meat sausage, ground fish meat, boiled fish paste, chikuwa (tubular fish cakes), hanpen (a cake of pounded fish), satsumaage (fried fish cakes), datemaki (rolled omelets mixed fish paste), whale bacon, and other ground marine products; butter, margarine, cheese, whip cream, and other such dairy-fatty products; udon noodles, hiyamugi (cold wheat noodles), somen (thin wheat noodles), soba, Chinese soba noodles, spaghetti, macaroni, rice noodles, harusame (thin noodles made from bean starch), wonton, and other such pastas; as well as various types of side dishes and processed foods such as wheat gluten bread and denbu (mashed and seasoned fish). Preferably, the food and drink are beverages and sweets.

The food and drink of the present invention can be produced according to methods commonly used for the production of food and drink, except for mixing the readily water-soluble myricitrin composition in any of the production steps. The method for mixing the readily water-soluble myricitrin composition, or the order in which the components are mixed are not particularly limited. However, it is preferable that the readily water-soluble myricitrin composition be mixed with various materials at early stages of the production steps, preferably before the heat-treatment step or before exposure to light.

Examples of the cosmetics of the present invention include cosmetics that contain flavorings, particularly the flavorings (flavor components) above, including skin cosmetics (such as lotions, emulsions, and creams), lipsticks, sunscreen cosmetics, and makeup cosmetics. Examples of the drugs include drugs that contain flavorings, particularly the flavorings (flavor components) above, including tablets, capsule formulations, drinkable preparations, troches, and gargling solutions. Examples of the quasi drugs comprise quasi drugs that contain flavorings, particularly the flavorings (flavor components) above, including toothpastes, mouthwashes, and mouth odor preventive agents. Examples of the feeds include feeds that contain flavorings, particularly the flavorings (flavor components) above, including various pet foods such as cat food and dog food, and feeds for aquarium fish and farmed fish. These are non-limiting examples.

The cosmetics, drugs, quasi drugs, feeds, and other such products can be produced according to methods commonly used for these products, except for mixing the readily water-soluble myricitrin composition in any of the production steps. The time to mix the readily water-soluble myricitrin composition mixed with the cosmetics, drugs, quasi drugs, or feeds is not particularly limited. However, it is preferable that the readily water-soluble myricitrin composition be mixed with various materials at early stages of the flavoring production steps, preferably before the heat-treatment step or before exposure to light.

The amount of the flavor deterioration suppressing agent of the present invention added to various scented products such as food and drink, cosmetics, drugs, quasi drugs, and feeds is not particularly limited, as long as the deterioration of the flavor component contained in these products can be prevented. The type and the content of the flavor component contained in the scented product can be appropriately selected and decided taking into consideration factors such as the type and the intended use of the product, and the components contained therein. For example, the flavor deterioration suppressing agent (readily water-soluble myricitrin composition) may be mixed so that the readily water-soluble myricitrin composition is contained in the scented product in a proportion of at least 0.0003 mass %, preferably 0.0003 to 0.03 mass %, more preferably 0.0006 to 0.015 mass % in terms of the myricitrin amount.

### (5-3) Flavor Deterioration Suppressing Method

The present invention also provides a flavor deterioration suppressing method for various compositions that contain a flavoring or a flavor component.

The flavoring of the present invention may be any flavoring, including natural flavorings (plant natural flavorings, animal natural flavorings) and synthetic flavorings, both in simple and preparation forms, regardless of the producing method and form (water-soluble flavorings, oily flavorings, emulsion flavorings, powder flavorings), and whether it is used for food or cosmetics.

Preferably, the flavoring is a citrus-based flavoring such as orange, lemon, and grapefruit flavorings, or a milk-based flavoring such as milk, butter, cheese, and yogurt flavorings.

As used herein, various compositions that contain a flavoring (flavoring-containing compositions, scented compositions) encompass a wide range of compositions that contain the flavoring, preferably the citrus- or milk-based flavor component. Specific examples include various scented products such as the flavorings, food and drink, cosmetics, drugs, quasi drugs, and feeds above.

The method of the present invention can be effected by having the scented product coexist with the readily water-soluble myricitrin composition or the flavor deterioration suppressing agent of the present invention. The coexisting form of these components is not particularly limited, as long as these are present in contact with each other. For example, such a coexisting form may be obtained by mixing the readily water-soluble myricitrin composition or the flavor deterioration suppressing agent of the present invention with the scented product. When the scented product is a flavoring or a food or drink, the coexisting state can be achieved by mixing the readily water-soluble myricitrin composition or the flavor deterioration suppressing agent of the present invention as one of the material components during the production of the flavoring or the food or drink. This is also possible in other scented products such as cosmetics, drugs, quasi drugs, and feeds.

The proportion of the readily water-soluble myricitrin composition or the flavor deterioration suppressing agent of the present invention used for the scented product is not particularly limited as long as the effects of the present invention can be obtained, and may be appropriately adjusted according to the type of the flavoring of interest. The proportion of the readily water-soluble myricitrin composition or the flavor deterioration suppressing agent of the present invention used for the scented product is not particularly limited, and may be such that the readily water-soluble myricitrin composition is contained in the scented product in a proportion of at least 0.0003 mass %, preferably 0.0003 to 0.03 mass %, more preferably 0.0006 to 0.015 mass % in terms of the myricitrin amount.

The flavor deterioration suppressing method of the present invention can significantly suppress the flavor deterioration of the scented product.

The flavor deterioration suppressing method of the present invention excels in the effect of suppressing the flavor deterioration caused by light or heat in flavor component-containing compositions, particularly citrus-based flavor component-containing compositions, and can impart heat resistance or light resistance to compositions that contain such flavorings.

As used herein, “heat resistance” refers to the property that resists flavor deterioration (including reduction and alteration) even under the influence of heat. Specifically, the term “heat resistance” refers to the property to significantly suppress the flavor deterioration of the flavoring or flavoring-containing composition placed under the heat (increased temperature and heat) present in the normal storage conditions or in production steps, compared to flavorings or flavoring-containing compositions that do not contain the flavor deterioration suppressing agent. Examples of such conditions include exposing the flavoring or the flavoring-containing composition to a temperature of 60° C. for several tens of hours to 1 month, or 40° C. for 1 day to 6 months.

As used herein, “light resistance” refers to the property that resists flavor deterioration (including reduction and alteration) even under the influence of sunlight or artificial light (such as fluorescent light). Specifically, the term “light resistance” refers to the property to significantly suppress the flavor deterioration of the flavoring or flavoring-containing composition placed under the light (such as sunlight and fluorescent light) present in the normal storage conditions, compared to flavorings or flavoring-containing compositions that do not contain the flavor deterioration suppressing agent. Examples of such conditions include exposing the flavoring or the flavoring-containing composition to sunlight for 5 minutes to several hours, or to fluorescent light for 1 day to 6 months.

### EXAMPLES

The following specifically describes the substance of the present invention using the Experiment Examples and Examples below. It should be noted that the descriptions below merely represent one aspect of the present invention, and do not limit the present invention in any way. In the following, the symbol “%” means “mass %,” unless otherwise stated. Further, the symbols “MY,” “γ-CD,” and “MY-CD” mean myricitrin, γ-cyclodextrin, and the myricitrin inclusion product of cyclodextrin, respectively. Further, the products with the symbol “*” are San-Ei Gen F.F.I., Inc. products, and the product names with the symbol “**” are the registered trademarks of San-Ei Gen F.F.I., Inc.

### Preparation Example 1

### Preparation of MY

Ten kg of methanol was added to 1 kg of pulverized dry myrica, and extraction was performed for 5 hours at about 60° C. After filtration, the residue was washed with 3 kg of methanol, thereby obtaining about 10 kg of solution extracted with methanol. The solution was concentrated and transferred to another container to be subjected to drying under reduced pressure, thereby obtaining 0.25 kg of pale yellow powder.

The resulting solid was pulverized, and dissolved in 4 kg of methanol by heating at about 60° C. Then, 20 kg of water was added to precipitate MY. The precipitated MY was isolated by filtration, and subjected to drying under reduced pressure, thereby obtaining 0.2 kg of MY. The obtained MY was analyzed under the following conditions, which revealed that the HPLC purity of MY was 99.2%.

HPLC Analysis Conditions

Column: Inertsil ODS-2 Φ4.6×250 mm (produced by GL Sciences Inc.)

Mobile phase: water/acetonitrile/TFA=850/15/2

Detection: the absorbance at a wavelength of 351 nm

Flow rate: 0.8 ml/min.

### Example 1

### Preparation of Readily Water-Soluble MY Composition

MY (the MY obtained in Preparation Example 1 was used) and γ-CD (produced by Wacker Chemical; used in this Example, and in the rest of the Examples below) were mixed at a mole ratio of 1:3 (a total mass of 3.8 g). After adding 100 ml of tap water, the mixture was heated to about 90° C., and stirred for 15 min to dissolve the solid component. The solution was filtered through a filter paper, and dried to concentrate using an evaporator. The resulting dry solid was powdered with a mixer to prepare a powdery MY composition (3.7 g).

### Example 2

### Preparation of Powdery MY Composition

MY (the MY obtained in Preparation Example 1 was used) and γ-CD (produced by Wacker Chemical; used in this Example, and in the rest of the Examples below) were mixed at a mole ratio of 1:1.2 (a total mass of 5.2 g). After adding 34.8 g of dextrin, and 60 ml of tap water, the mixture was heated to about 90° C., and stirred for 15 minutes to dissolve the solid component. The solution was filtered through a filter paper, and dried to concentrate using an evaporator. The resulting dry solid was powdered with a mixer to prepare a powdery MY composition (38 g).

### Example 3

### Preparation of Powdery MY Composition

MY (the MY obtained in Preparation Example 1 was used) and γ-CD (produced by Wacker Chemical; used in this Example, and in the rest of the Examples below) were mixed at a mole ratio of 1:1.2 (a total mass of 10.4 g). After adding 29.6 g of dextrin, and 60 ml of tap water, the mixture was heated to about 90° C., and stirred for 15 minutes to dissolve the solid component. The solution was filtered through a filter paper, and dried to concentrate using an evaporator. The resulting dry solid was powdered with a mixer to prepare a powdery MY composition (38 g).

### Experiment Example 1

### Evaluation of MY Composition Solubility in Water

The MY and γ-CD were used in the proportions (mole ratios) presented in Table 1, and twenty different powdery MY compositions (Samples 1 to 22) were prepared according to the method of Example 1.

The powdery MY composition (Samples 1 to 22) or a control MY (MY itself) was added to water (20 ml) in a 100-ml Erlenmeyer flask while stirring. The samples were added until they could not be dissolved further, and formed deposits. Each solution was shaken (Bio-Shaker BR-3000LF, 160 rpm, amplitude=40 mm, Taitec Co., Ltd.) at 25° C. for 40 hours, and centrifuged at 9,000 rpm for 10 min to collect the supernatant. The supernatant was appropriately diluted with a 0.1% phosphoric acid aqueous solution, and absorbance (346 nm) was measured. From the measured absorbance, the MY concentration (mg/ml) in the supernatant was calculated as the solubility of the MY composition (Samples 1 to 22) and MY (non-inclusion), using a standard curve created beforehand in the manner described below. Further, the MY solubility of the MY composition (Samples 1 to 22) relative to the reference solubility (mg/ml) 1 of the MY (non-inclusion) was also calculated (hereinafter, “solubility (fold)”).

### Standard Curve Creating Method (Spectrophotometer)

1) MY (50 mg) was accurately weighed, and dissolved in methanol to make the volume precisely 100 ml.
2) The solution was appropriately diluted with a 0.1% phosphoric acid aqueous solution to prepare MY solutions of 0.0001, 0.0005, 0.001, 0.005, and 0.01 mg/ml concentrations.
3) The absorbance of the standard solution at a wavelength of maximum absorption was measured with a spectrophotometer.
4) A standard curve was created based on the content of MY in the MY solution, and the measured absorbance value.

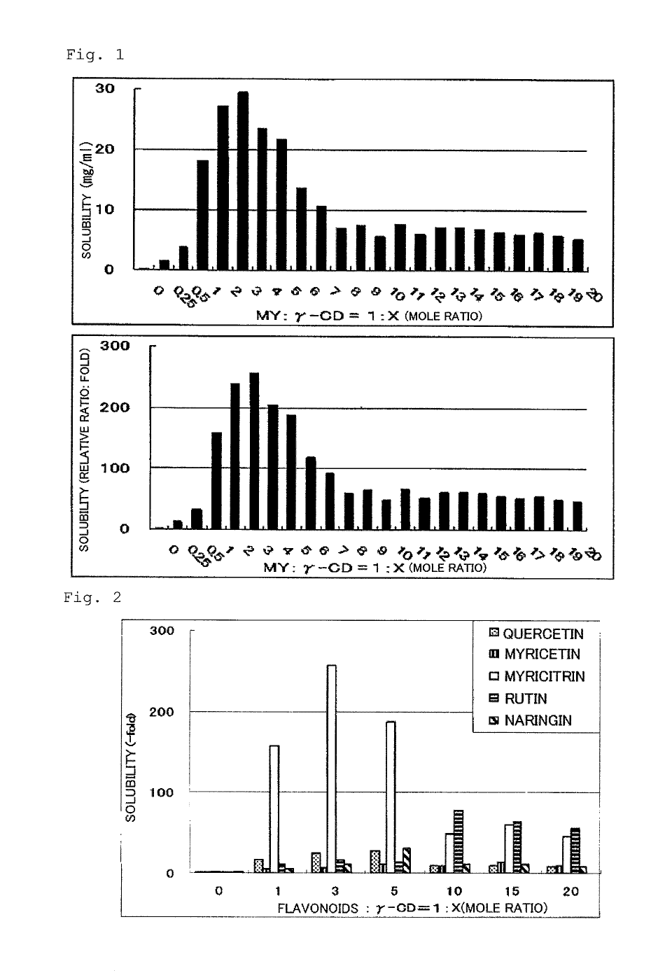

The results are presented in Table 1 and in FIG. 1 (solubility (mg/ml) and solubility (fold)).

TABLE 1

| | | | | Solubility | |
|---|---|---|---|---|---|
| | MY:γ-CD = 1:X | | | (in terms of | |
| | Mole ratio | Mass ratio | | myricitrin, | Solubility |
| Sample | (x) | (x) | pH | mg/ml) | (fold) |
| Control | 0 | 0 | 4.70 | 0.12 | 1 |
| Sample 1 | 0.25 | 0.7 | 4.69 | 1.56 | 13.5 |
| Sample 2 | 0.5 | 1.4 | 4.70 | 3.69 | 32.0 |
| Sample 3 | 1 | 2.8 | 4.70 | 18.20 | 157.8 |
| Sample 4 | 2 | 5.6 | 4.71 | 27.36 | 237.2 |
| Sample 5 | 3 | 8.4 | 4.68 | 29.54 | 256.2 |
| Sample 6 | 4 | 11.2 | 4.71 | 23.56 | 204.3 |
| Sample 7 | 5 | 14.0 | 4.73 | 21.60 | 187.4 |
| Sample 8 | 6 | 16.8 | 4.98 | 13.69 | 118.7 |
| Sample 9 | 7 | 19.6 | 5.01 | 10.66 | 92.4 |
| Sample 10 | 8 | 22.4 | 5.03 | 6.98 | 60.6 |
| Sample 11 | 9 | 25.2 | 5.11 | 7.52 | 65.2 |
| Sample 12 | 10 | 28.0 | 5.28 | 5.69 | 49.3 |
| Sample 13 | 11 | 30.8 | 5.13 | 7.66 | 66.4 |
| Sample 14 | 12 | 33.6 | 5.07 | 5.96 | 51.7 |
| Sample 15 | 13 | 36.4 | 5.19 | 7.18 | 62.3 |
| Sample 16 | 14 | 39.2 | 5.22 | 7.09 | 61.5 |
| Sample 17 | 15 | 42.0 | 5.17 | 6.90 | 59.9 |
| Sample 18 | 16 | 44.8 | 5.22 | 6.37 | 55.2 |
| Sample 19 | 17 | 47.6 | 5.31 | 5.89 | 51.1 |
| Sample 20 | 18 | 50.4 | 5.51 | 6.28 | 54.5 |
| Sample 21 | 19 | 53.2 | 5.45 | 5.86 | 50.8 |
| Sample 22 | 20 | 56.0 | 5.45 | 5.33 | 46.3 |

It was found from these results that the use of 1 to 7 moles of γ-CD per mole of MY greatly improves the MY solubility by a factor of 90 or more (about 10 mg/ml or more), compared to dissolving the MY itself (0.12 mg/ml solubility). It was also found that the use of 1 to 6 moles, preferably 1 to 5 moles, more preferably about 2 to 5 moles, particularly preferably about 2 to 4 moles of γ-CD per mole of MY greatly improves the MY solubility by a factor of 100 or more (about 13 mg/ml or more), 150 or more (about 18 mg/ml or more), 180 or more (about 20 mg/ml or more), and 200 or more (about 23 mg/ml or more), respectively, compared to using the MY itself.

### Reference Experiment Example

### Evaluation of Water Solubility with α- and β-Cyclodextrins Instead of γ-CD, α-cyclodextrin (α-CD) and β-cyclodextrin (β-CD) (both from Nihon Shokuhin Kako Co., Ltd.) were used to prepare MY inclusions, and the solubility of the compositions in water was evaluated.

Specifically, an MY composition containing 3 moles of α-CD (Reference Sample 1), or an MY composition containing 3 moles of β-CD (Reference Sample 2) per mole of MY were prepared according to the method of Example 1, and the solubility of each composition in water was determined as an MY solubility (mg/ml) according to the method of Experiment Example 1. The solubility (mg/ml) of the MY itself was also determined as a control, and the solubility (fold) was calculated from the relative ratio of the two.

The results are presented in Table 2 along with the results of Sample 5 evaluated in Experiment Example 1.

TABLE 2

| | | |
|---|---|---|
| | Solubility | |
| | (in terms of | |
| | myricitrin, | Solubility |
| Sample | mg/ml) | (fold) |

| | | | |
|---|---|---|---|
| Control | MY alone | 0.10 | 1 |
| Reference | MY:α-CD = 1:3 | 0.27 | 2.6 |
| Sample 1 | (mole ratio) | | |
| Reference | MY:β-CD = 1:3 | 3.10 | 29.6 |
| Sample 2 | (mole ratio) | | |
| Sample 5 | MY:γ-CD = 1:3 | 29.54 | 256.2 |
| (Experiment | (mole ratio) | | |
| Example 1) | | | |

As can be seen from the results, the MY solubility in water is much lower in the compositions using α-CD and β-CD (Reference Samples 1 and 2) than in sample 5 using γ-CD, confirming that the improved water solubility of the MY composition of the present invention is specific to the use of γ-CD.

### Experiment Example 2

### Evaluation of the Solubility of Other Flavonoids in Water

γ-CD and the various flavonoids (MY, quercetin, myricetin, rutin, and naringin) presented in Table 3 were used in the proportions (mole ratios) given in the table to prepare powder compositions according to the preparation method of Example 1.

The solubility (mg/ml) of each composition in water in terms of the flavonoid was then determined according to the method of Experiment Example 1. The solubility (mg/ml) of the flavonoid itself in water was also determined as a control, and the solubility (fold) was calculated from the relative ratio of the two.

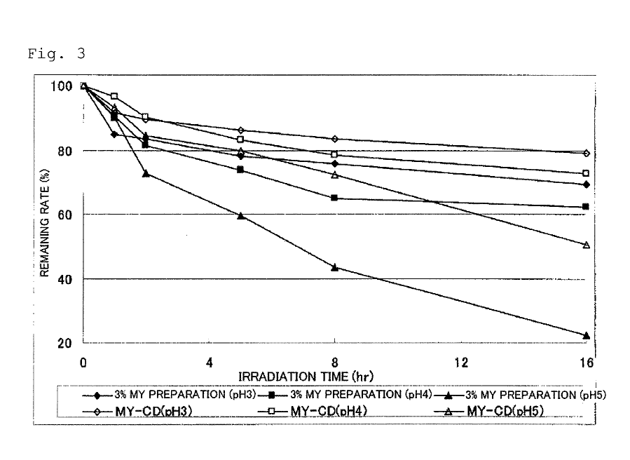

The results (solubility (fold)) are presented in Table 3 and FIG. 2.

TABLE 3

| Flavonoid:γ-CD = 1:X | Solubility (fold) (in terms of flavonoids) | | | | |
|---|---|---|---|---|---|
| (mole ratio) | MY | Quercetin | Myricetin | Rutin | Naringin |
| 0 | 1 | 1 | 1 | 1 | 1 |
| 1 | 157.8 | 17.2 | 5.0 | 10.7 | 5.4 |
| 3 | 256.2 | 24.9 | 7.6 | 16.1 | 10.7 |
| 5 | 187.4 | 27.7 | 10.6 | 13.5 | 31.2 |
| 10 | 49.3 | 10.4 | 9.2 | 78.3 | 10.8 |
| 15 | 59.9 | 9.9 | 14.0 | 64.3 | 10.6 |
| 20 | 46.3 | 8.4 | 9.2 | 56.2 | 8.7 |

As can be seen from the results, the solubility in water is much lower in samples using the flavonoids, namely, quercetin, myricetin, rutin, and naringin, than in using MY, confirming that the improved water solubility of the composition of the present invention is specific to the combined use of γ-cyclodextrin and myricitrin.

### Experiment Example 3

### Evaluation of Preservation Stability (Presence or Absence of Deposits)

MY and γ-CD were used in the 1:1 proportion (mole ratio) to prepare a powder composition (sample 1) according to the method of Example 1. The composition was dissolved in acid and sugar solutions of the composition below (pH values of 3, 6, and 9) to a final MY concentration of 0.1% or 0.05%. Each solution was hot-packed in a 100-ml glass vial (93° C.). The drinks so prepared were allowed to cool, and placed under 50° C., room temperature (25±2° C.), and low-temperature (5° C.) conditions for 210 days. The presence or absence of deposits was then checked by visual inspection.

Acid and Sugar Solution

### Acid and Sugar Solution Formulation

| | |
|---|---|
| 1. Sugar | 5.5 (%) |
| 2. Fructose glucose liquid sugar | 5.5 |
| 3. pH adjustment by citrate (anhydrate) or | |
| trisodium citrate | |
| | A total of 100% with water |

As a comparative experiment, MY and rutin (both in a simple form), and a powdery rutin composition (rutin:γ-CD=1:1, mole ratio) prepared according to the method of Example 1 were dissolved in acid and sugar solutions of the composition above (pH values of 3, 6, and 9) to a final flavonoid concentration of 0.1% or 0.05%, and hot-packed in a 200-ml PET bottle (93° C.) as above. The drinks so prepared were allowed to cool, and placed under 50° C., room temperature (25±2° C.), and low-temperature (5° C.) conditions for 210 days. The presence or absence of deposits was then observed.

The results are presented in Table 4. In the table, the symbol “+” means the presence of deposits, and “−” the absence of deposits. The symbol “x” means no dissolution in the acid and sugar solution.

TABLE 4

| | |
|---|---|
| | Flavonoid |
| Preservation | concentration (%) |

| Sample | pH | method | 0.10 | 0.05 |
|---|---|---|---|---|
| MY | 3 | 50° C. | + | + |
| | | Room temperature | + | + |
| | | Refrigerated | + | + |
| | 6 | 50° C. | − | − |
| | | Room temperature | + | + |
| | | Refrigerated | + | + |
| | 9 | 50° C. | − | − |
| | | Room temperature | − | − |
| | | Refrigerated | − | − |
| Rutin | 3 | 50° C. | x | x |
| | | Room temperature | x | x |
| | | Refrigerated | x | x |
| | 6 | 50° C. | x | + |
| | | Room temperature | x | + |
| | | Refrigerated | x | + |
| | 9 | 50° C. | + | − |
| | | Room temperature | + | − |
| | | Refrigerated | + | − |
| MY/ | 3 | 50° C. | − | − |
| γ-CD | | Room temperature | − | − |
| | | Refrigerated | − | − |
| | 6 | 50° C. | − | − |
| | | Room temperature | − | − |
| | | Refrigerated | − | − |
| | 9 | 50° C. | − | − |
| | | Room temperature | − | |
| | | Refrigerated | − | − |
| Rutin/ | 3 | 50° C. | + | + |
| γ-CD | | Room temperature | + | + |
| | | Refrigerated | + | + |
| | 6 | 50° C. | + | + |
| | | Room temperature | + | + |
| | | Refrigerated | + | + |
| | 9 | 50° C. | + | − |
| | | Room temperature | + | + |
| | | Refrigerated | + | + |

As the results show, the rutin as the inclusion product of γ-CD had slightly improved solubility in water, but was very unstable, as demonstrated by the formation of deposits during preservation. In contrast, the MY as the inclusion product of γ-CD had greatly improved solubility in water (see Experiment Example 1), and formed no deposits even when preserved under different pH and temperature conditions (pH of 3 to 9, low temperature to 60° C.), demonstrating that the solubility can be maintained over extended time periods; and, specifically, that the preservation solubility can be improved.

Further, the MY having a formulation of MY: γ-CD=1:1 to 3 and the inclusion product of γ-CD were stably dissolved without undergoing precipitation for at least two months, even when they were added to acid and sugar solutions as myricitrin concentrations in an amount of 0.1%.

### Experiment Example 4

### Evaluation of Fading Suppressing Effect

MY or an MY composition was incorporated in an acidic solution, and subjected to irradiation using a Fade Meter. Then comparison was carried out with regard to MY residual amount after the irradiation, thereby evaluating degradation stability during the conservation.

Specifically, an acidic solution having the formulation below was prepared, and mixed with a 3% MY preparation (product name: SanMelin**Y-AF*) or a MY/γ-CD inclusion product (MY: γ-CD=1:1.2) (containing 3% myricitrin) prepared in Example 2 to a final MY concentration of 0.05%.

### Formulation of Acidic Solution

| | |
|---|---|
| 1. Citric acid (anhydrous) | 0.1(%) |
| 2. Trisodium citrate | pH adjustment (pH 3, 4 or 5) |

Each solution was subjected to light irradiation using an ultraviolet Fade Meter (UV Long-Life Fade Meter FAL-3: Suga Test Instruments Co., Ltd.) for 1 to 16 hours. The MY amount after the irradiation was measured by HPLC, thereby finding a MY residual rate (%) after irradiation.

FIG. 3 shows the results.

The results show that degradation due to ultraviolet irradiation was suppressed by using MY as a γ-CD inclusion product. More specifically, resistance to ultraviolet irradiation (storage stability) increased by using MY as a γ-CD inclusion product.

### Experiment Example 5

### Evaluation of Fading Suppressing Effect

The fading suppressing effects of the MY and MY composition were evaluated using various colorants presented in Table 5 below.

Specifically, a colorant-containing acidic drink of the formulation below was prepared. Then, a 3% MY preparation (product name: SanMelin**Y-AF*) and a MY/γ-CD inclusion product (MY: γ-CD=1:1.2) (containing 3% myricitrin) prepared in Example 2 were added to the drink to a final MY concentration of 0.003% or to a final γ-CD (Wacker Chemical) concentration of 0.01%. Further, as a positive control, a 15% enzyme-treated isoquercitrin (EMIQ) preparation (product name: SanMelin**AO-3000*) was added thereto to a final EMIQ concentration of 0.015%.

### Formulation of Colorant-Containing Acidic Drink

| | |
|---|---|
| 1. Sugar | 5.5 (%) |
| 2. Fructose glucose liquid sugar | 5.5 |
| 3. Citric acid (anhydrous) | 0.08 |
| 4. Trisodium citrate | pH adjustment (pH 3.1) |
| 5. Colorant | Table 5 |
| | A total of 100% with water |

TABLE 5

| | | Amount |
|---|---|---|
| Colorant | Product name | added (%) |
| Purple corn colorant | San Red** NO. 5F* | 0.05 |
| Red cabbage colorant | San Red** RCFU* | 0.05 |
| Purple sweet potato colorant | San Red** YMF* | 0.05 |
| Grape juice colorant | San Red** GA* | 0.10 |
| Elderberry colorant | San Red** ELF* | 0.05 |
| Safflower yellow colorant | San Yellow** NO. 2 SFU | 0.05 |
| β-carotene | Carotene Base NO. 80-S* | 0.05 |
| Paprika colorant | Paprika Base 150* | 0.05 |
| Cochineal colorant | San Red** NO. 1* | 0.05 |
| Monascus colorant | San Red** TMA* | 0.03 |
| Gardenia blue colorant | San Blue** NO. 2756* | 0.05 |

The drinks were irradiated with a UV Fade Meter (UV Long-Life Fade Meter FAL-3, Suga Test Instruments Co., Ltd.) or a fluorescent light (BIOTRON LH 300, NK System) for the durations presented in Tables 6 and 7. Absorbance was measured before and after the irradiation, and the percentage of remaining color (%) after the irradiation was calculated. Further, as a control test, a colorant-containing acidic drink was irradiated with the UV Fade Meter or fluorescent light as above without adding anything (no addition), and the percentage of remaining color (%) after the irradiation was calculated.

TABLE 6
Fade Meter irradiation time

| Colorant | Irradiation time (H) |
|---|---|
| Purple corn colorant (0.05%) | 4 |
| Red cabbage colorant (0.05%) | 10 |
| Purple sweet potato colorant (0.05%) | 7 |
| Grape juice colorant (0.1%) | 2 |
| Elderberry colorant (0.05%) | 2 |
| Safflower yellow colorant (0.05%) | 4 |
| β-carotene (0.05%) | 17 |
| Paprika colorant (0.05%) | 3 |
| Cochineal colorant (0.05%) | 6 |
| Monascus colorant (0.035%) | 3 |
| Gardenia blue colorant (0.05%) | 19 |

TABLE 7
Fluorescence irradiation time

| Colorant | Irradiation time (D) |
|---|---|
| Purple corn colorant (0.05%) | 2 |
| Red cabbage colorant (0.05%) | 4 |
| Purple sweet potato colorant (0.05%) | 6 |
| Grape juice colorant (0.1%) | 4 |
| Elderberry colorant (0.05%) | 6 |
| Safflower yellow colorant (0.05%) | 6 |
| β-carotene (0.05%) | 1 |
| Paprika colorant (0.05%) | 6 |
| Cochineal colorant (0.05%) | 1 |
| Monascus colorant (0.035%) | 4 |

The results for the UV Fade Meter irradiation and the results for the fluorescent light irradiation, are presented in Tables 8 and 9, respectively.

TABLE 8
UV Fade Meter irradiation

| | No | | MY-CD | | EMIQ |
|---|---|---|---|---|---|
| | addi- | SanMelin** | inclusion | | prep- |
| Colorant | tion | Y-AF* | product | γ-CD | aration |
| Purple corn colorant | 66.4 | 84.2 | 92.3 | 72.8 | 93.5 |
| Red cabbage colorant | 40.2 | 76.5 | 90.7 | 53.9 | 91.2 |
| Purple sweet potato | 42.8 | 83.4 | 87.2 | 46.5 | 90.1 |
| colorant | | | | | |
| Grape juice colorant | 63.2 | 75.5 | 91.3 | 75.0 | 82.9 |
| Elderberry colorant | 64.8 | 91.9 | 94.3 | 68.5 | 92.1 |
| Safflower yellow | 42.8 | 71.9 | 79.8 | 48.6 | 80.6 |
| colorant | | | | | |
| β-carotene | 34.2 | 90.6 | 93.1 | 68.5 | 58.9 |
| Paprika colorant | 47.5 | 79.5 | 88.0 | 50.3 | 88.1 |
| Cochineal colorant | 64.7 | 84.8 | 91.4 | 64.3 | 89.2 |
| Monascus colorant | 25.2 | 56.5 | 61.3 | 30.2 | 32.9 |
| Gardenia blue | 63.8 | 73.5 | 79.4 | 68.6 | 76.6 |
| colorant | | | | | |

TABLE 9
Fluorescent light irradiation

| | No | | MY-CD | | EMIQ |
|---|---|---|---|---|---|
| | addi- | SanMelin** | inclusion | | prep- |
| Colorant | tion | Y-AF* | product | γ-CD | aration |
| Purple corn colorant | 56.2 | 75.3 | 78.8 | 65.5 | 72.8 |
| Red cabbage colorant | 59.8 | 72.5 | 82.2 | 62.8 | 68.9 |
| Purple sweet potato | 77.6 | 85.9 | 89.6 | 80.4 | 83.3 |
| colorant | | | | | |
| Elderberry colorant | 63.7 | 70.3 | 74.2 | 63.8 | 68.9 |
| Safflower yellow | 63.8 | 74.3 | 81.3 | 68.1 | 72.3 |
| colorant | | | | | |
| β-carotene | 47.1 | 75.8 | 87.1 | 67.4 | 82.4 |
| Paprika colorant | 64.3 | 89.3 | 90.6 | 71.2 | 79.7 |
| Cochineal colorant | 55.4 | 73.8 | 78.5 | 64.2 | 78.5 |
| Monascus colorant | 39.7 | 40.3 | 43.0 | 38.7 | 40.2 |
| Gardenia blue | 53.8 | 65.5 | 69.0 | 58.4 | 64.8 |
| colorant | | | | | |

As can be seen from these results, it was confirmed that the MY, capable of exhibiting the fading suppressing effect alone, can have an improved fading suppressing effect as an inclusion product of γ-CD.

### Experiment Example 6

### Evaluation of Flavor Deterioration Suppressing Effect

Various drinks mixed with the MY or MY composition were subjected to a light or heat stress test (accelerated test) to evaluate the flavor deterioration suppressing effect of the MY or MY composition.

### (1) Preparation of Drinks

Specifically, eight drinks were prepared in the formulations 1 to 8 below. Then, a 3% MY preparation (product name: SanMelin**Y-AF*), a MY/γ-CD inclusion product preparation (MY: γ-CD=1:1.2) (containing 3% MY) prepared in Example 2, a MY/γ-CD inclusion product preparation (MY: γ-CD=1:1.2) (containing 6% MY) prepared in Example 3, and γ-CD (Wacker Chemical) were added thereto in the final concentrations shown in FIG. 10. Further, as a positive control, a 15% Enzymatically Modified Isoquercitrin (EMIQ) preparation (product name: SanMelin**AO-3000*) was added thereto to a final concentration shown in FIG. 10.

### Formulation 1: Grape Drink (pH 3.1)

| | |
|---|---|
| Fructose glucose liquid sugar | 10 (%) |
| Five-times concentrated transparent Concord | 4.4 |
| grape juice | |
| Citric acid (anhydrous) | 0.15 |
| Trisodium citrate | 0.01 |
| Grape flavor NO. 63554* | 0.1 |
| | A total of 100% with water |

### Formulation 2: Lemon Drink (pH 3.2)

| | |
|---|---|
| Sugar | 6 (%) |
| Citric acid (anhydrous) | 0.08 |
| Trisodium citrate | 0.08 |
| From-concentrate lemon fruit juice | 3.0 |
| Lemon flavor NO. 2404* | 0.1 |
| | A total of 100% with water |

### Formulation 3: Grapefruit Drink (100% Juice; pH 3.4)

| | |
|---|---|
| Grapefruit frozen juice 45 | 20 (%) |
| Grapefruit flavor NO. 2512* | 0.1 |
| | A total of 100% with water |

### Formulation 4: Grapefruit Drink (20% Juice; pH 3.2)

| | |
|---|---|
| Grapefruit frozen juice 45 | 4 (%) |
| Fructose glucose liquid sugar | 5 |
| Sugar | 4 |
| Citric acid (anhydrous) | 0.1 |
| Trisodium citrate | 0.02 |
| L-ascorbic acid | 0.02 |
| Grapefruit flavor NO. 2512* | 0.1 |
| | A total of 100% with water |

### Formulation 5: Orange Drink (20% Juice %; pH 3.5)

| | |
|---|---|
| Citrus mixed fruit juice 53 | 4 (%) |
| Fructose glucose liquid sugar | 5 |
| Sugar | 4 |
| Citric acid (anhydrous) | 0.1 |
| Trisodium citrate | 0.02 |
| L-ascorbic acid | 0.02 |
| Orange flavor NO. 2410* | 0.1 |
| | A total of 100% with water |

### Formulation 6: Coffee Drink (pH 6.3)

| | |
|---|---|
| Sugar | 6.5 (%) |
| Coffee extract | 55 |
| Whole powdered milk | 0.76 |
| Powdered skim milk | 1.11 |
| Emulsifier (Homogen** NO. 352*) | 0.05 |
| Sodium bicarbonate | 0.07 |
| Coffee flavor NO. 63378* | 0.05 |
| | A total of 100% with water |

### Formulation 7: Milk Tea (pH 6.8)

| | |
|---|---|
| Black tea leaf | 0.4 (%) |
| Milk | 6 |
| Whole powdered milk | 1.4 |
| Sugar | 6 |
| Emulsifier (Homogen** NO. 1890*) | 0.167 |
| | A total of 100% |
| | with water |

### Formulation 8: Sour Milk Beverage (pH 3.3)

| | |
|---|---|
| Fermented milk | 10 (%) |
| Sugar | 7 |
| Citric acid (anhydrous) | 0.07 |
| Soybean polysaccharide (SM-1200*) | 0.2 |
| Pectin (SM-600(A)*) | 0.07 |
| Emulsifier (Homogen** NO. 2429*) | 0.1 |
| Yogurt flavor NO. 61127* | 0.1 |
| ST flavor NO. 9702* | 0.03 |
| | A total of 100% |
| | with water |

### (2) Evaluation Test for Flavor Deterioration Suppression

The drinks prepared as above were tested under the severity conditions presented in Table 10, and changes in drink flavor after the test were examined by six panelists in a sensory evaluation. Evaluations were made according to the following criteria on a scale of 1 (a drink with no addition (blank)) to 5 (each drink before the test).

### Evaluation Criteria

5: No change from before the test
4: Slight change from before the test
3: Little change from before the test
2: Notable change from before the test
1: Considerable change from before the test (comparable to the blank)

Table 10 presents mean values of the scored points evaluated by the six panelists.

TABLE 10

| | | | MY-CD | MY-CD | | |
|---|---|---|---|---|---|---|
| | | | inclusion | inclusion | | |
| | | SanMelin**Y-AF* | product | product | | EMIQ |
| | | (MY 3%) | (MY 3%) | (MY 6%) | γ-CD | Preparation |
| | Severity condition | 0.1% | 0.1% | 0.1% | 0.01% | 0.1% |
| Grape drink | Fluorescent light (20000 1x, 15 hr, 15° C.) | 2.2 | 3.7 | 4.1 | 1.6 | 2.9 |
| Lemon drink | Fluorescent light (20000 1x, 21 hr, 10° C.) | 2.3 | 3.7 | 3.6 | 2.2 | 2.7 |
| Grapefruit drink | Fluorescent light (20000 1x, 18 hr, 15° C.) | 2.3 | 3.7 | 4.0 | 2.1 | 3.3 |
| (100% fruit juice) | | | | | | |
| Grapefruit drink | Fluorescent light (20000 1x, 21 hr, 10° C.) | 2.4 | 3.7 | 3.7 | 2.0 | 3.0 |
| (20% fruit juice) | Heat (55° C., 64 hr) | 2.7 | 3.1 | 3.7 | 2.8 | 2.6 |
| | Fade Meter (1.5 hr) | 2.4 | 3.5 | 3.6 | 2.2 | 2.9 |
| Orange drink | Fluorescent light (20000 1x, 18 hr, 15° C.) | 2.3 | 3.5 | 3.6 | 2.3 | 3.1 |
| (20% fruit juice) | | | | | | |
| Coffee | Fluorescent light (20000 1x, 16 hr, 15° C.) | 2.1 | 4.0 | 4.1 | 2.4 | 3.3 |
| Milk tea | Fluorescent light (20000 1x, 18 hr, 15° C.) | 2.5 | 3.7 | 3.7 | 2.3 | 3.1 |
| Sour milk beverage | Fluorescent light (20000 1x, 18 hr, 15° C.) | 3.0 | 3.7 | 3.7 | 2.7 | 2.9 |

These results confirmed that the use of MY as an inclusion product of γ-CD, rather than by itself, can further suppress flavor deterioration in all of the drinks. Specifically, it was found that the MY composition of the present invention has a better flavor deterioration suppressing effect than the MY itself. Further, the MY composition of the present invention had no unusual smell or taste.

1. A readily water-soluble myricitrin composition that comprises γ-cyclodextrin in a proportion of 1 to 7 moles per mole of myricitrin.

2. The readily water-soluble myricitrin composition according to claim 1, wherein the myricitrin is an inclusion product of the γ-cyclodextrin.

3. The readily water-soluble myricitrin composition according to claim 2, wherein the readily water-soluble myricitrin composition is a color deterioration suppressing agent.

4. A color preparation that comprises a color with the readily water-soluble myricitrin composition of claim 3.

5. The readily water-soluble myricitrin composition according to claim 2, wherein the readily water-soluble myricitrin serves as a flavor deterioration suppressing agent.

6. A scented product that comprises a flavor component with the readily water-soluble myricitrin composition of claim 5.

7. A liquid or semiliquid edible composition that comprises the readily water-soluble myricitrin composition of claim 2 in the state of being dissolved in water or in aqueous ethanol.

8. The liquid or semiliquid edible composition according to claim 7, wherein the edible composition is a drink.

9. An edible composition obtained by solidifying a liquid or semiliquid edible composition of claim 7.

10. A method for producing the readily water-soluble myricitrin composition of claim 2, the method comprising including the myricitrin in γ-cyclodextrin in a proportion of 1 to 7 moles of the γ-cyclodextrin per mole of the myricitrin.

11. The method according to claim 10, comprising subjecting the mixture that contains the γ-cyclodextrin and the myricitrin in a proportion of 1 to 7 moles of the γ-cyclodextrin per mole of the myricitrin to the following steps A or B,
A. (1) dissolving the mixture in a heated aqueous solution, and (2) drying the aqueous solution,
B. (1) dissolving the mixture in a heated aqueous solution, and clarifying the aqueous solution, and (2) drying the aqueous solution.

12. A method for improving solubility of myricitrin in water and for suppressing the deposition of myricitrin in an aqueous solution of pH 3 to 9, the method comprising including myricitrin in γ-cyclodextrin in a proportion of 1 to 7 moles of the γ-cyclodextrin per mole of the myricitrin.

13. (canceled)

14. (canceled)

15. The readily water-soluble myricitrin composition according to claim 1, wherein the readily water-soluble myricitrin composition is a color deterioration suppressing agent.

16. A color preparation that comprises a color with the readily water-soluble myricitrin composition of claim 15.

17. The readily water-soluble myricitrin composition according to claim 1, wherein the readily water-soluble myricitrin serves as a flavor deterioration suppressing agent.

18. A scented product that comprises a flavor component with the readily water-soluble myricitrin composition of claim 17.

19. A liquid or semiliquid edible composition that comprises the readily water-soluble myricitrin composition of claim 1 in the state of being dissolved in water or in aqueous ethanol.

20. The liquid or semiliquid edible composition according to claim 19, wherein the edible composition is a drink.

21. An edible composition obtained by solidifying a liquid or semiliquid edible composition of claim 19.

22. A method for producing the readily water-soluble myricitrin composition of claim 1, the method comprising including the myricitrin in γ-cyclodextrin in a proportion of 1 to 7 moles of the γ-cyclodextrin per mole of the myricitrin.

23. The method according to claim 22, comprising subjecting the mixture that contains the γ-cyclodextrin and the myricitrin in a proportion of 1 to 7 moles of the γ-cyclodextrin per mole of the myricitrin to the following steps A or B,
A. (1) dissolving the mixture in a heated aqueous solution, and (2) drying the aqueous solution,
B. (1) dissolving the mixture in a heated aqueous solution, and clarifying the aqueous solution, and (2) drying the aqueous solution.
